(19) United States
(12) Patent Application Publication
(10) Pub. No.: US 2012/0258853 A1
(43) Pub. Date: Oct. 11, 2012

(54) POROUS PARTICLES WITH MASKING POWDER AND METHODS OF MAKING AND USING THE SAME

(75) Inventors: Badri Veeraraghavan, Woodbury, MN (US); Brinda B. Badri, Woodbury, MN (US)

(73) Assignee: 3M Innovative Property Company

(21) Appl. No.: 13/084,206

(22) Filed: Apr. 11, 2011

(51) Int. Cl. B01J 20/26; B01J 20/18

(52) U.S. Cl. 502/62; 502/402

(57) ABSTRACT

A porous particle with a non-polymeric masking powder on at least a portion of its outer surface is disclosed. The non-polymeric masking powder is not attached to the outer surface of the porous particle with a polymeric binder, and the masked porous particle is hydrophobic. Absorbent articles, for example, diapers and sanitary napkins, and absorbent components of absorbent articles that include a plurality of the masked porous particles are also disclosed. A method of making the masked porous particle is also disclosed.

### BACKGROUND

Certain porous particles have a wide variety of uses in the chemical arts. For example, some porous particles may be useful for desiccating, deodorizing, or decolorizing in certain environments. Porous particles useful for these purposes typically work by adsorbing water and/or volatile organic compounds (e.g., which may be odiferous agents or other undesirable components). Adsorption of volatile organic compounds renders some porous particles useful, for example, for catalysis, odor control, and air and water purification.

A particularly widely used adsorbent porous particle is activated carbon. However, the surface properties of native activated carbon are not always appropriate for the desired application, and activated carbon may lose some efficacy as an absorbent when it is wet. Furthermore, the black color of activated carbon makes it undesirable for some applications, e.g., in disposable absorbent articles such as diapers or sanitary napkins.

Some methods of coating the surface of activated carbon and changing its color, for example, have been reported. See, e.g., U.S. Pat. Nos. 3,746,655 (Urbanic); 4,732,805 (Maggs); and 5,407,442 (Karapasha); and 6,740406 (Hu et al.) and U.S. Pat. App. Pub. No. 2005/0123763 (Hiltzik et al.).

### SUMMARY

The present disclosure relates to a porous particle with a masking powder on at least a portion of its outer surface. At least the outer surface of the masked porous particle is hydrophobic. Porous particles with the masking powder advantageously retain much of their original absorption capacity, measured without the masking powder. The porous particles may be useful, for example, for adsorbing odors within the environment of an absorbent article or other environments where the porous particles are exposed to moisture. A method of making the masked porous particle is also disclosed.

In one aspect, the present disclosure provides a masked porous particle comprising: a porous particle with an outer surface and a non-polymeric masking powder on at least a portion of the outer surface of the porous particle, wherein the non-polymeric masking powder is not attached to the outer surface of the porous particle with a polymeric binder, and wherein the masked porous particle has a hydrophobic outer surface.

In some embodiments, the non-polymeric masking powder is an anionic clay (e.g., hydrotalcite). In some of these embodiments, the anionic clay is intercalated with an organic acid. In some of these embodiments, without wishing to be bound by theory, it is believed the organic acid renders the anionic clay hydrophobic.

In other embodiments of the aforementioned masked porous particle, the porous particle has a surface treatment providing covalently bonded hydrophobic groups on at least a portion of its outer surface, with the non-polymeric masking powder on at least a portion of the treated outer surface. In some of these embodiments, the non-polymeric masking powder is an anionic clay (e.g., hydrotalcite).

In another aspect, the present disclosure provides a plurality of particles comprising the masked porous particle disclosed herein and at least one of superabsorbent polymers, hydrophilic nonwovens, or wood pulp.

In another aspect, the present disclosure provides an absorbent component comprising an absorbent material in combination with a plurality of particles comprising the masked porous particle disclosed herein. In some embodiments, the absorbent material is at least one of wood pulp, a superabsorbent polymer, or an absorbent foam.

In another aspect, the present disclosure provides an absorbent article comprising an absorbent component as described in any of the above aspects or embodiments or an absorbent article comprising a plurality of the masked porous particles as described in any of the above aspects or embodiments. In some embodiments, the absorbent article is an underarm pad, a breast pad, a dress shield, a foot pad, a wound dressing, a bed pad or liner, a diaper, an incontinence pad, or a sanitary napkin. In some embodiments, the absorbent article comprises a liquid permeable topsheet, a liquid impermeable backsheet, and the absorbent component and/or the plurality of particles described above disposed between the topsheet and the backsheet.

In another aspect, the present disclosure provides the use of the masked porous particle disclosed herein (or a plurality of the masked porous particles disclosed herein) as an odor-control agent. In some embodiments, the odor-control agent is exposed to aqueous liquids. In some embodiments, the odor-control agent is used in an absorbent article.

In another aspect, the present disclosure provides a method of controlling odor, the method comprising placing a masked porous particle disclosed herein (or a plurality of the masked porous particles disclosed herein) in an environment with an amount of an odiferous agent, wherein the masked porous particle reduces the amount of the odiferous agent in the environment. In some embodiments, the masked porous particle is in contact with aqueous liquids. In some embodiments, the environment is in an absorbent article (e.g., on the body of a wearer).

In another aspect, the present disclosure provides a method of making a masked porous particle according to any one of the foregoing embodiments, the method comprising providing a porous particle and dry blending the non-polymeric masking powder with the porous particle to provide the masked porous particle.

The masked porous particles according to and/or useful for practicing the present disclosure are at least partially hydrophobic. Typically the masked porous particles absorb liquid water (and other aqueous liquids) at a much lower rate or to a much lower extent than comparable untreated porous particles. Hydrophobic groups on the external surface of the masked porous particle help repel aqueous liquids. The internal pore surfaces remain useful for adsorbing odiferous agents, water vapor, or other components of the environment to which the masked porous particles are exposed.

Odor-control agents (e.g., activated carbon, silica gel, or zeolites) can have a diminished or inconsistent efficacy when they are exposed to aqueous liquids. The masked porous particles disclosed herein typically repel aqueous liquids and are shown in the present disclosure to reduce odor when wet more reliably than untreated porous particles. Due to their at least partially hydrophobic character, they can be added to absorbent articles without the use of pouches or other cumbersome physical isolation techniques.

### DEFINITIONS

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “at least one of” followed by a list of two or more items refers to any one of the items in the list and any combination of two or more items in the list.

The term “non-polymeric” refers to a molecule having a structure that does not include the multiple repetition of units derived from molecules of low relative molecular mass.

The term “polymeric” refers to a molecule having a structure that includes the multiple repetition of units derived from molecules of low relative molecular mass.

The term “binder” refers to an adhesive or film that is used to attach two components such as a masking powder and an adsorbent particle.

“Hydrophilic” describes surfaces that are wettable by aqueous liquids (i.e., liquids comprising water) in contact with the surfaces. Wettability can be measured by contact angle of the liquid on the surface. Typically, a surface is hydrophilic when the contact angle of water on the surface is less than 90°.

“Hydrophobic” describes surfaces that are nonwettable by aqueous liquids (i.e., liquids comprising water) in contact with the surfaces. Typically, a surface is hydrophobic when the contact angle of water on the surface is greater than 90°. Masked porous particles according to the present disclosure that have hydrophobic groups or a hydrophobic masking powder on at least a portion of their outer surface are considered hydrophobic or at least partially hydrophobic.

“Hydrophobic group” describes functional groups that render surfaces nonwettable by aqueous liquids (i.e., liquids comprising water) in contact with the surfaces.

“At least a portion of the outer surface” can include uniform or non-uniform coverage of the porous particle by the masking powder. In some embodiments, the entire outer surface of the porous particle is covered by the masking powder.

The term “absorbent component”, refers to a component generally used as the primary absorbent component of an absorbent article, such as the absorbent core of the absorbent article. It also includes absorbent components, such as the secondary topsheets described herein that serve a wicking or storage function. The term absorbent component, however, excludes components that are generally only used as the topsheet or backsheet of the absorbent article.

“Disposable” is generally understood to mean something that has a limited period of use before its ability to perform its intended function is exhausted. With regard to garments, “disposable” garments typically are not constructed to withstand laundering.

Aqueous means including water. The term “aqueous fluids” encompasses biological fluids.

“Aliphatic” refers to non-aromatic carbon-containing compounds, which may be straight-chain, branched, or cyclic and may be saturated or unsaturated.

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms. “Alkylene” is the divalent form of “alkyl”.

The term “fluoroalkyl” includes linear, branched, and/or cyclic alkyl groups in which all C—H bonds are replaced by C—F bonds as well as groups in which hydrogen or chlorine atoms are present instead of fluorine atoms provided that up to one atom of either hydrogen or chlorine is present for every two carbon atoms. In some embodiments of fluoroalkyl groups, when at least one hydrogen or chlorine is present, the fluoroalkyl group includes at least one trifluoromethyl group. The term “perfluoroalkyl group” includes linear, branched, and/or cyclic alkyl groups in which all C—H bonds are replaced by C—F bonds.

“Arylalkylene” refers to an “alkylene” moiety to which an aryl group is attached.

The term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Arylene” is the divalent form of the “aryl” groups defined above.

“Alkylarylene” refers to an “arylene” moiety to which an alkyl group is attached.

“Plasma treatment” refers to a process where high frequency electric or magnetic fields are used to create free radicals of a particular gas in an atmosphere where a porous particle is present. The free radicals modify the surface of the porous particles. The term “plasma treatment” can encompass “plasma deposition”, in which a film formed from the plasma is deposited on at least a portion of the surface and is generally attached to the surface through covalent bonds.

All numerical ranges are inclusive of their endpoints and non-integral values between the endpoints unless otherwise stated.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic representation of a method of making masked porous particles and the resulting masked porous particles according to some embodiments of the present disclosure;

FIG. 2 is a schematic representation of a method of making masked porous particles and the resulting masked porous particles according to other embodiments of the present disclosure;

FIG. 3A is a schematic side view of an apparatus used to treat porous particles in the vapor phase in an illustrative method of making surface-treated porous particles according to some embodiments of the present disclosure;

FIG. 3B is a schematic perspective view of the particle agitator portion of the apparatus in FIG. 3A;

FIG. 3C is a schematic side view of another exemplary apparatus used to treat porous particles with a first and second vapor phase in another illustrative method of making surface-treated porous particles according to some embodiments of the present disclosure; and

FIG. 4 is a schematic exploded view of an exemplary absorbent article according to the present disclosure.

### DETAILED DESCRIPTION

### Particles

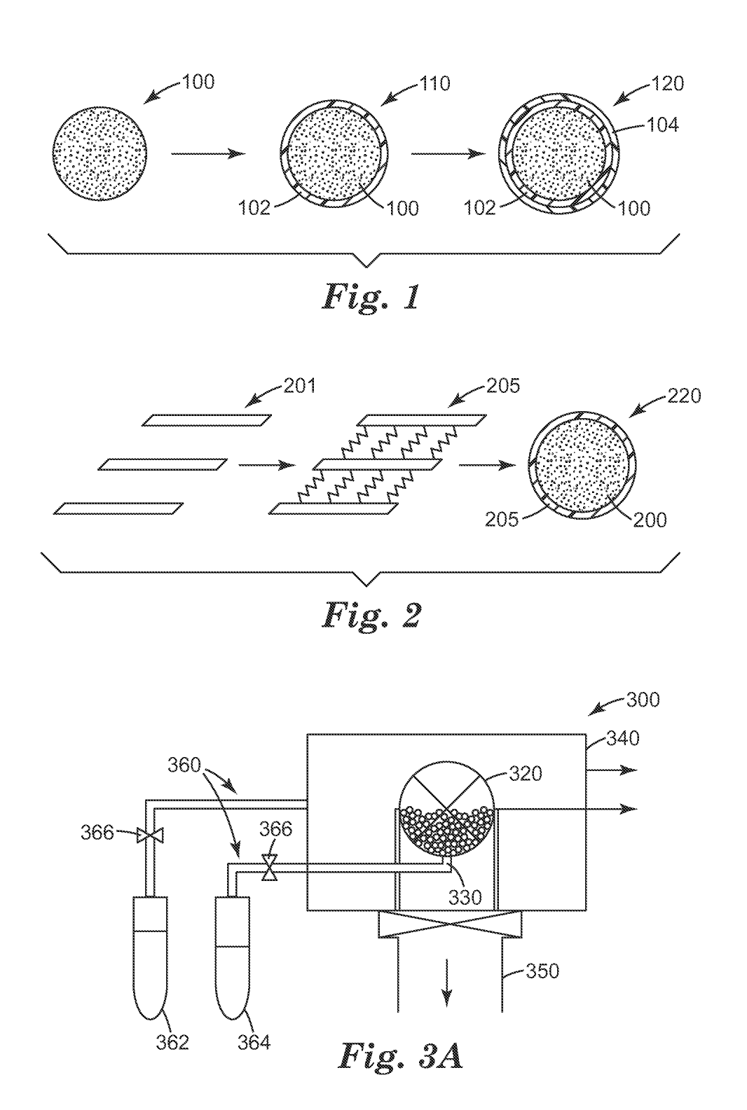

A schematic illustration of treating a porous particle 100 and a masked porous particle 120 according to some embodiments of the present disclosure is shown in FIG. 1. Starting porous particle 100 has an outer surface and interior pore surfaces. In general, the outer surface of porous particle 100 is not hydrophobic. In some embodiments, both the outer surface and interior pore surfaces of porous particle 100 are hydrophilic due to multiple hydrophilic groups (e.g., hydroxyl groups such as phenolic groups, carboxylic acid groups, or lactone groups) (not shown) on the surfaces. In the illustrated embodiment, porous particle 110 is provided with a hydrophobic outer surface, which is represented by hydrophobic surface treatment 102 on the outer surface of the porous particle 100. The surface treatment 102 typically includes covalently bonded hydrophobic groups (not shown) on at least a portion of the outer surface of the porous particle. In some embodiments, treated porous particle 110 remains substantially untreated on its interior pore surfaces. In the embodiment of the masked porous particle according to the present disclosure that is shown in FIG. 1, masked porous particle 120 has a non-polymeric masking powder 104 on at least a portion of the treated outer surface 102. Typically, the non-polymeric masking powder 104 is physisorbed on the treated outer surface 102 of the porous particle.

The non-polymeric masking powder 104 is a solid referred to as “masking” because it is capable of covering at least a portion of the outer surface of the porous particle. The masking powder 104 generally has a particle size that is smaller (e.g., at least 2, 3, 5, or 10 times smaller) than the porous particle so that it can cover at least a portion of the outer surface of the porous particle. In some embodiments, the masking powder 104 may be present in the form of aggregates of nanoparticles. These aggregates may have a median size in a range of from about 0.1 micrometers to about 20 micrometers, or in a range of about 0.1 micrometers to about 10 micrometers, or in a range of about 0.1 micrometers to about 1 micrometer. In some embodiments, the masking powder has an average particle size in a range from 10 nanometers (nm) to 1 micrometer (e.g., from 20 nm to 800 nm, 50 nm to 500 nm, or 75 nm to 500 nm). In some embodiments, the masking powder may have a maximum particle size up to 5, 4, 3, or 2 micrometers. The non-polymeric masking powder 104 may be an inorganic masking powder, which in some embodiments is a surface-modified inorganic powder. In some embodiments, the non-polymeric masking powder 104 is a mineral powder, which is inclusive of naturally occurring and synthetic materials. The non-polymeric masking powder 104 may be, for example, a clay (e.g., an anionic clay such as a naturally occurring or synthetic layered double hydroxide or a cationic clay such as montmorillonite, kaolin, or bentonite); an inorganic oxide such as titanium dioxide (e.g., anatase, rutile, or other forms), silica, alumina, zinc oxide, magnesium oxide, aluminum trihydroxide, or zirconium oxide; other materials such as calcium carbonate, calcium sulfate, calcium bicarbonate, mica, barium sulfate, talc (i.e., hydrated magnesium silicate); or combinations thereof. The masking powder 104 is not polytetrafluoroethylene. In some embodiments, the masked porous particle disclosed herein is substantially free of polytetrafluoroethylene. “Substantially free of” polytetrafluoroethylene typically means that there is less than one, 0.5, 0.25, or 0.1 percent by weight polytetrafluoroethylene based on the total weight of the masked porous particle and includes being free of polytetrafluoroethylene.

In some embodiments, the non-polymeric masking powder 104 is an anionic clay. In some of these embodiments, the non-polymeric masking powder 104 is a layered double hydroxide. Layered double hydroxides are generally represented by formula [M^{z+}₁₋ₓM³⁺ₓ(OH)₂]^{q+} (Xⁿ⁻)_{q/n}.yH₂O, where z is typically 2, and M²⁺ is Ca²⁺, Mg²⁺, Mn²⁺, Fe²⁺, Co²⁺, Ni²⁺, Cu²⁺ or Zn²⁺. Typically, q is equal to x, where x is in a range from 0.1 to 0.5, in some embodiments, 0.2 to 0.33. In any of these embodiments, X represents a generic anion, and the value of y is typically in a range from 0.5 to 4. In some embodiments, including embodiments wherein the non-polymeric masking powder is an anionic clay, the non-polymeric masking powder 104 is hydrotalcite (i.e., [Mg₆Al₂(OH)₁₆]CO₃.4H₂O), which may be naturally occurring or synthetic.

In embodiments of the masked porous particles 120 according to the present disclosure having a surface treatment 102, including the embodiment illustrated in FIG. 1, at least a portion of the outer surface of the porous particle comprises hydrophobic groups. Exemplary hydrophobic groups include alkyl groups and fluoroalkyl groups having up to 20, 18, 15, 12, 10, or 8 carbon atoms (e.g., in a range from 1 to 20, 1 to 15, 1 to 10, 1 to 5, or 1 to 3 carbon atoms). Further examples of hydrophobic groups include aryl, arylalklyenyl, or alkylarylenyl groups, each of which may be substituted with one or more fluoro groups. In some embodiments, the hydrophobic groups include at least one of methyl, trifluoromethyl, difluoromethyl, or fluoromethyl groups. In some embodiments, the hydrophobic groups comprise siloxanes having alkyl groups, aryl groups, arylalkylenyl (e.g., benzyl) groups, alkylarylenyl groups, or combinations thereof. The alkyl groups on the siloxanes have up to 20, 18, 15, 12, 10, or 8 carbon atoms (e.g., in a range from 1 to 20, 1 to 15, 1 to 10, 1 to 5, or 1 to 3 carbon atoms) and may optionally be substituted with one or more fluoro groups.

In embodiments of the masked porous particles 120 according to the present disclosure having a surface treatment 102, typically a major portion (e.g., greater than 50 or at least 51, 55, 60, 65, 70, 75, 80, 85, 90, or 95 percent) of the outer surface area of porous particle 100 is covered by hydrophobic groups. In some embodiments, a substantial portion (e.g., at least 90, 95, 96, 97, 98, or 99 percent up to 100 percent) of the outer surface comprises hydrophobic groups. Techniques for analyzing the outer surface coverage of a particle are known in the art (e.g., infrared, raman, and nuclear magnetic resonance spectroscopy); see, e.g., L. A. Belyakova et al., Colloids and Surfaces A: Physicochemical and Engineering Aspects, 154 (1999), pp. 285-294. The outer surface of a particle can also be analyzed by electron spectroscopy chemical analysis (ESCA). ESCA can be used to report the atomic percent of various elements on a surface. The results depend, for example, on the particular hydrophobic groups on the surface and the method of applying them to the surface.

In some embodiments of the masked porous particles 120 according to the present disclosure having a surface treatment 102, at least some of the interior pore surfaces of the porous particle are not treated. Methods for evaluating the interior pore surfaces of porous particles are known in the art. For example, absorption techniques (e.g., using methanol, ethanol, water, benzene, or nitrogen) are commonly used. Since a large percentage of surface area in porous particles is in the interior pore surfaces, large changes in absorption typically result when the wettability of the interior pore surfaces is altered. Porous particles may also be cross-sectioned and their interior chemical compositions analyzed using ESCA as described above or time-of-flight secondary ion mass spectrometry (TOF-SIMS). In some embodiments, minimal to no hydrophobic groups are observed on the interior of the treated porous particles using these techniques. In these embodiments, the interior pore surfaces are said to be “substantially untreated”. In some embodiments, the interior pore surfaces of the treated porous particles disclosed herein have minimal to no alkyl or aryl groups, optionally substituted with fluorine, as evidenced by TOF-SIMS. In the case of TOF-SIMS, relative quantification of hydrophobic to hydrophilic functional groups is possible, typically by taking a ratio of counts for a mass of a hydrophobic group over counts for a hydrophilic group. Ratios of counts from the external surface can be compared to ratios of counts from the interior surface.

A schematic illustration of treating a porous particle 200 and a masked porous particle 220 according to other embodiments of the present disclosure is shown in FIG. 2. In the illustrated embodiment, clay 201 (e.g., a naturally occurring or synthetic layered double hydroxide including any of those described above, such as hydrotalcite, or a cationic clay such as montmorillonite or bentonite) has a layered structure. In the embodiment illustrated in FIG. 2, the layered structure is intercalated with an aliphatic compound, for example, to provide the intercalated clay 205. Intercalation is a form of self-assembly that involves reversible insertion of a guest species into a host structure. X-ray diffraction techniques can be used to identify the expansion of the host layer structure after the intercalation of the guest species. In some embodiments, the clay 201 is an anionic clay (e.g., a layered double hydroxide), and the guest is an organic acid selected, for example, to make the intercalated clay 205 hydrophobic. In other embodiments, the clay 201 is a cationic clay (e.g., bentonite), and the guest is a quaternary amine, for example, selected to make the intercalated clay 205 hydrophobic.

As mentioned above, useful clays include layered double hydroxides, which are unique intercalation hosts having positively charged layers and changed balancing anions in the interlayer regions. An exemplary layered double hydroxide, hydrotalcite, typically exhibits strong intralayer covalent bonding and weaker interlayer interactions, with carbonate anions and water molecules present in the interlayer space. The interlayer anions can be replaced by a variety of guest species through an anion exchange process. A wide variety of anionic species such as chloride, nitrate, carboxylic acids, fatty acids, vitamins, and ibuprofen can be intercalated in the hydrotalcite host by replacing carbonate ions and water molecules. Linear molecules with anionic functional groups (e.g., mono- and difunctional carboxylic acids such as fatty acids) may replace the carbonate anions and water molecules and self-assemble into monolayers or bilayers between the layers of hydrotalcite. The carboxylic acid ends form hydrogen bond to the hydrotalcite layer and the hydrophobic end align in the interlayer space resulting in hydrophobic hydrotalcite material.

The organic acid useful as an intercalation guest, for example, is generally an aliphatic carboxylic acid that may be saturated or unsaturated and may be monofunctional or multifunctional (e.g., difunctional). In some embodiments, the organic acid has at least 6 carbon atoms. In some embodiments, the organic acid is an unbranched, monofunctional or difunctional saturated aliphatic acid having from 8 to 28 (in some embodiments, 8 to 24, 8 to 20, or 9 to 20) carbon atoms. In some embodiments, the organic acid comprises a C₆₋₂₆ alkyl or C₆₋₂₆ alkenyl, wherein the C₆₋₂₆ alkyl or C₆₋₂₆ alkenyl is substituted by one or more (e.g., one or two)-CO₂H groups. In some of these embodiments, the C₆₋₂₆ alkyl or C₆₋₂₆ alkenyl is unbranched. In some embodiments, the alkyl or alkenyl group has 6 to 22, 6 to 18, or 7 to 18 carbon atoms. Exemplary organic acids that are useful for practicing the present disclosure include lauric acid, myristic acid, palmitic acid, stearic acid, arachidic acid, behenic acid, lignoceric acid, cerotic acid, myristoleic acid, palmitoleic acid, sapienic acid, oleic acid, linoleic acid, α-linolenic acid, arachidonic acid, eicosapentaenoic acid, erucic acid, docosahexaenoic acid, sebacic acid, and azelaic acid. In some embodiments, the organic acid is stearic acid or sebacic acid. In the embodiment of the masked porous particle according to the present disclosure that is shown in FIG. 2, masked porous particle 220 has the intercalated anionic clay 205 on at least a portion of its outer surface. Typically the intercalated anionic clay 205 is physisorbed on the outer surface of porous particle 200.

In both embodiments of masked porous particles illustrated in FIGS. 1 and 2, the masked porous particle 120 and 220 has a hydrophobic outer surface. In the embodiment illustrated in FIG. 1, the surface-treatment 102 is hydrophobic. In the embodiment illustrated in FIG. 2, the intercalated clay 205 is hydrophobic, but the porous particle 200 is not provided with an additional hydrophobic surface treatment. In some embodiments, masked porous particle 120 can be provided with a hydrophobic surface treatment 102, and the hydrophobic intercalated clay (205 shown in FIG. 2) may be used as the masking powder.

In some embodiments of the masked porous particle according to the present disclosure, the masking power has a hydrophobic surface treatment. For example, the masking powder may be a hydrophobic surface-modified inorganic material such as an inorganic oxide or clay. Exemplary hydrophobic surface-modified clays include surface-modified montmorillonite clay. Exemplary hydrophobic inorganic oxides include surface-modified silica or surface-modified titanium dioxide, which are commercially available (e.g., hydrophobic fumed silica is available, for example, from Evonik Industries, Krefeld, Germany, under the trade designation “AEROSIL”). In some embodiments, the masking powder is a surface-modified hydrophobic titanium dioxide. An exemplary hydrophobic titanium dioxide is a silica-zirconia surface-modified titanium dioxide with an organic hydrophobic treatment available, for example, from Sachtleben Chemie GmbH, Dusiburg, Germany. Hydrophobic surface-modified inorganic materials can be physisorbed directly onto at least a portion of the outer surface of a porous particle 100 or 200 or may be used in conjunction with a hydrophobic surface treatment 102.

In some embodiments of the masked porous particle according to the present disclosure, including any of the embodiments mentioned above, the masking powder is present on the masked porous particles at a level of 1 to 50 percent by weight, in some embodiments, 5 to 40 percent by weight, in some embodiments, 10 to 30 percent by weight, and in some embodiments 15 to 25 percent by weight, based on the total weight of the masked porous particles.

The hydrophobic nature of the masked porous particles 120 and 220 according to the present disclosure can be evaluated, for example, using contact angle measurements on individual particles or bulk particles using techniques known in the art. In some embodiments, the contact angle of a water droplet on the porous particles 120 and 220 is at least 120, 110, 100, or 95 degrees (e.g., in a range from 90 to 100 degrees, 95 to 110 degrees, 100 to 115 degrees, 110 to 130 degrees, or 115 to 125 degrees). The hydrophobic nature of the particles can also be measured using the Liquid Water Uptake evaluation described in the Examples, below. Porous particles can have a liquid water uptake at room temperature that is up to about 80 percent of their weight. In some embodiments, the liquid water uptake of the masked porous particle according to the present disclosure is reduced at least about 30, 40, 50, 60, or 70 percent in comparison to comparative particles that are the same as the masked porous particles (that is, they have the same size and pore size distribution and the same chemical make-up) except without any masking powder or hydrophobic treatment.

In some embodiments of the masked porous particle disclosed herein, the non-polymeric masking powder is a whitening agent. Degrees of whitening can be determined, for example, by standard chromaticity methods, for example, the CIELAB color space scale established by the International Commission on Illumination. The CIELAB scale has three parameters, L*, a*, and b*. “L*” is a brightness value, “a*” is a measure of the redness (+a) and greenness (−a), and the “b*” value is a measure of yellowness (+b) and blueness (−b). For both the “a*” and “b*” values, the greater the departure from 0, the more intense the color. “L*” ranges from 0 (black) to 100 (highest intensity). In embodiments where the porous particle is an activated carbon particle, the masking powder can significantly increase the L* value of the particle. The porous particle according to the present disclosure can have an L* value of at least about 40, in some embodiments at least about 55, in some embodiments at least about 60, and in some embodiments at least about 75. Measurement of particles to obtain CIELAB L* values is done with a spectrophotometer obtained from Datacolor International, Lawrenceville, N.J., under the trade designation “MICROFLASH”, Model No. 100 using the method described in the Examples, below.

Porous particles 100 and 200 which may be masked to provide masked porous particles according to present disclosure include silica gel particles, zeolite particles, silicates, molecular sieves, and activated carbon. The porous particle may have an average particle size in a range from 0.075 millimeter (mm) to 10 mm (e.g., from 0.1 mm to 10 mm, 0.2 mm to 5 mm, or 0.25 mm to 1 mm). The median pore size may vary as long as the pores are large enough to allow access to odiferous agents (when the masked porous particles are used for odor control), water molecules (when the masked porous particles are used as a desiccant), or other components desired for a particular application. In some embodiments, the interior pores have a median pore size in a range from 0.3 nanometers (nm) to 10 nm (e.g., 0.3 nm to 3 nm, 2 nm to 7 nm, 4 nm to 7 nm, 8 nm to 10 nm, or 4 nm to 10 nm). In some embodiments, the masked porous particles have a bimodal porous structure wherein the pores have two different median sizes selected from any of the listed ranges. The porous particles 100 and 200 before masking can be obtained from a variety of commercial sources. For example, silica gel particles are available from AGM Container Controls, Inc., Tucson, Ariz.; International Silica Gel Co., LTD, Shandong, China; and SIGMA-ALDRICH, St. Louis, Mo. Zeolites (e.g., zeolite A, zeolite P, zeolite Y, zeolite X, zeolite DAY, zeolite ZSM-5, and/or mixtures thereof) are available, for example, from Degussa A G, Dusseldorf, Germany.

In some embodiments, the porous particle 100 and 200 is an activated carbon particle. As used herein, “activated carbon” refers to highly porous carbon having a random or amorphous structure. Activated carbon products useful for practicing the present disclosure include granules and pellets of activated carbon available, for example, from Calgon Carbon, Inc. (Pittsburgh, Pa.), MeadWestvaco Corporation (Charleston, S.C.), and Kuraray Chemical Co., Ltd. (Osaka, Japan). Activated carbon from any source can be used, including that derived from bituminous coal or other forms of coal, or from pitch, coconut shells, corn husks, polyacrylonitrile (PAN) polymers, charred cellulosic fibers or materials, and wood. Activated carbon particles can, for example, be formed directly by activation of coal or other materials, or by grinding carbonaceous material to a fine powder, agglomerating it with pitch or other adhesives, and then converting the agglomerate to activated carbon.

In some embodiments, activated carbon useful for practicing the present disclosure is provided with functional groups to modify the surface properties of the product. For example, during the activation stage, the carbon can be exposed to nitric acid to add carboxylic acid groups, hydrogen chloride to add chlorine groups, to oxygen or water vapor to add oxygen or hydroxyl groups, to ammonia to add amine groups, and to hydrogen to add hydrogen atoms. Methods of surface modification of activated carbon to produce acidic, basic, and neutral functional groups are described in Shen et al., “Surface Chemical Functional Groups Modification of Porous Carbon”, Recent Patents on Chemical Engineering, 2008, 1, 27-40. Alternatively, a compound such as a non-gaseous molecule may be added to the carbon prior to activating it or prior to a post-treatment step, wherein the compound reacts at elevated temperature to add functional groups to the activated carbon. Such a process is described, for example, in U.S. Pat. No. 5,521,008, (Lieberman et al.).

In some embodiments, the porous particle further comprises an odor-reducing or odor-masking agent within at least some of its pores. The odor-reducing or odor-masking agent may be incorporated into the porous particle, for example, before the masking powder is applied. Activated carbon in any form can be impregnated with other materials to increase the adsorption of specific species. For example, activated carbon impregnated with an acid can be used to increase the ability of activated carbon to adsorb ammonia. This odor-reducing acid may be, for example, a benign acid such as citric acid, boric acid, ascorbic acid, salicylic acid, or acetic acid. In some embodiments, the odor-reducing acid is any of the organic acids described above for intercalation into the anionic clay. Such organic acids can render at least a portion of the interior pores of the porous particle acidic to increase the capture of ammonia or ammonia-like components. The hydrophobic nature of these organic acids can cause them to be less likely to be leached out of the activated carbon after it is exposed to an aqueous liquid, for example. In some of these embodiments, the odor-reducing agent is sebacic acid or stearic acid. In other embodiments, impregnation with sodium hydroxide or other caustic compounds can be useful for removal of hydrogen sulfide. Impregnation with metals or metal salts such as copper sulfate and copper chloride is believed to be useful for removal of other sulfur compounds. Some of these types of impregnated activated carbon particles are commercially available, for example, from Calgon Carbon, Inc. (e.g., under the trade designations “CENTAUR” or “MINOTAUR”). Others can be made by spraying a solution of the odor-reducing or odor-masking agent onto the porous particles and subsequently oven-drying. Activated carbon may also be impregnated with a variety of salts, such as zinc salts, potassium salts, sodium salts, silver salts, and the like. Activated carbon may also be impregnated with a variety of perfumes, for example, to mask odors.

In any of the embodiments of masked porous particles 120 and 220 according to the present disclosure, the interior pore surfaces of the masked porous particle retain the capacity to adsorb odiferous agents, water vapor, or other components. In some embodiments a plurality of the masked porous particles has an adsorption capacity for an odiferous agent that is at least 60 (in some embodiments, at least 65, 70, 75, 80, 85, or 90) percent of an adsorption capacity of a comparative plurality of porous particles for the odiferous agent, wherein the comparative plurality of porous particles is the same as the plurality of the masked porous particles except without any masking powder or hydrophobic surface treatment. When the comparative plurality of particles is said to be the same as the plurality of masked porous particles, the comparative plurality of particles has the same size and pore size distribution as the masked porous particles and has the same chemical make-up as the masked porous particles before such particles are treated with a masking powder and optionally a hydrophobic surface treatment.

As used herein, an “odoriferous agent” can include compounds associated with body fluids that are known to cause unpleasant odors and can include other sources of malodor. Exemplary odoriferous agents include ammonia; isovaleric acid; amines (e.g., methyl, diethyl, triethyl and n-butyl amines); butyric acid; butyraldehyde; formaldehyde; acetaldehyde; toluene; benzene; furaldehyde; furfural; pyridine; di-n-propyl sulfide; indole; skatole (also known as 3-methylindole); ethyl mercaptan; and methyl mercaptan. Any of these compounds can be used as the odiferous agent in a comparison of the plurality of particles including the masked porous particle disclosed herein and the comparative plurality of particles. The adsorption capacity for each of these compounds can be measured according to methods known in the art and is typically evaluated by weight gain of the porous particles.

In some embodiments, the absorption capacity comparison between the plurality of masked porous particles and the comparative plurality of particles is determined using carbon tetrachloride as the odiferous agent. In these embodiments, adsorption capacity is measured using ASTM D3467 by flowing carbon tetrachloride through a sample of porous particles of known weight until there is no further increase in the weight of the sample and then determining the weight of the adsorbed carbon tetrachloride. The apparatus useful for the evaluation includes a means to control the supply air pressure, a means to remove oil and water in both liquid and vapor states from the supply air, a means to produce a specified concentration of carbon tetrachloride in the air flowed through the carbon sample, and a means to control the flow rate of the mixture of air and carbon tetrachloride through the sample.

Other agents that may be useful for evaluating adsorption capacity include hydrogen chloride, hydrogen cyanide, hydrogen sulfide, carbon disulfide, dimethyldisulfide, dimethyltrisulfide, phosgene, chlorine, and bromine.

In some embodiments, the absorption capacity comparison between the plurality of masked porous particles and the comparative plurality of particles is determined after the plurality of the masked porous particles has been exposed to an aqueous liquid. In these embodiments, the comparative plurality of particles typically has not been exposed to aqueous liquids. Even after the plurality of masked porous particles has been exposed to aqueous liquids, a plurality of the masked porous particles has an adsorption capacity for an odiferous agent that is at least 60 (in some embodiments, at least 65, 70, 75, 80, 85, or 90) percent of an adsorption capacity of a comparative plurality of porous particles for the odiferous agent.

In some embodiments, when exposed to aqueous liquid, the plurality of masked porous particles disclosed herein adsorbs at least one odiferous agent to a greater extent (in some embodiments, at least 5, 10, 20, 30, 40, or 50 percent more) than a comparative plurality of particles that is the same as the plurality of the masked porous particles except without any masking powder or hydrophobic surface treatment. In these embodiments, the odiferous agent may be any of the odiferous agents mentioned above. When the comparative plurality of particles is said to be the same as the plurality of masked porous particles, the comparative plurality of particles has the same size and pore size distribution as the masked porous particles and has the same chemical make-up as the masked porous particles before such particles are treated with a masking powder and optionally a hydrophobic surface treatment. In some embodiments, the aqueous liquid is a body fluid (e.g., urine or menses). In some embodiments, the odiferous agent is ammonia. In some embodiments, adsorption of an odiferous agent is measured using a Drager tube. In some embodiments, adsorption of an odiferous agent is measured according to the Odorant Test Method described in the Examples below.

### Methods of Making the Particles

In some embodiments, the method of making a masked porous particle 120 and 220 according to any of the embodiments mentioned above comprises providing a porous particle 100 and 200 and physically blending the masking powder with the porous particle to provide the masked porous particle of the present disclosure. Physical blending can be carried out by techniques involving mechanical and/or electrostatic mixing of particles. These techniques tend to result in a uniform coating of the masking powder on the outer surface of porous particles. Solvents can optionally be included to disperse the masking powder and to assist in uniformly coating the porous particles. In some embodiments, physically blending is carried out by dry blending. “Dry blending” refers to blending the porous particle 100 and 200 and the inorganic masking powder in the absence of water and organic solvents. Dry blending may also be referred to as a solventless process. Methods of such blending have been described in Pfeffer et al., “Synthesis of Engineered Particulates with Tailored Properties Using Dry Particle Coating”, Powder Technology 117 (2001) 40-67; and Hersey, “Ordered Mixing: A New Concept in Powder Mixing Practice”, Powder Technology, 11 (1975) 41-44. Dry blending can be carried out, for example, via convective mixing, diffusive mixing, and shear mixing mechanisms. For example, coating the porous particle with the masking powder can be carried out by tumbling the porous particle and the masking powder using a conventional tumbling mixers (e.g., V-blender, double cone, or rotating cube); convective mixers (e.g., ribbon blender, nautamixer); fluidized bed mixers; or high-shear mixers. Dry blending of the masking powder and the porous particles is advantageous because no heating is necessary to evaporate residual water or solvents, which can eliminate process steps and reduce cost.

In some embodiments, including the embodiment illustrated FIG. 2, described above, the masking powder is an anionic clay intercalated with an organic acid, including any of the organic acids described above. Intercalation can be carried out, for example, by co-precipitation of the anionic clay host and the organic acid guest, by direct solid state reaction at elevated temperature, and ion exchange methods (e.g., mediated by glycerol or surfactants). In some embodiments when the organic acid is a solid, the intercalation is carried out by dry blending the anionic clay and the organic acid using the dry blending techniques described above. The resulting mixture can then be heated at an elevated temperature (e.g., in a range from 75° C. to 175° C.) to cause the intercalation reaction to Occur.

In some embodiments, including the embodiment illustrated in FIG. 1, described above, the porous particle 100 has a surface treatment 102 providing covalently bonded hydrophobic groups on at least a portion of its outer surface. Accordingly, in some embodiments, the method of making a masked porous particle disclosed herein includes surface-treating the porous particle to provide covalently bonded hydrophobic groups on at least a portion of its outer surface. The covalently bonded hydrophobic groups may be any of the hydrophobic groups described above. In some embodiments, it is desirable that methods of providing hydrophobic groups on at least a portion of the outer surface of the porous particles allow the interior pore surfaces of the porous particles to remain substantially free of such hydrophobic groups. Methods of treating porous particles to provide hydrophobic groups on the surface are described, for example, in copending application nos. PCT/US2010/057717 and PCT/US2010/057720, both filed on Nov. 23, 2010, and incorporated herein by reference in their entirety.

Hydrophobic groups can be installed on the outer surfaces of porous particles, for example, by plasma treatment. Methods of plasma treatment of porous materials are provided in U.S. Pat. Nos. 6,878,419 (David et al.). Also, methods and apparatuses for plasma treatment of particles are provided in U.S. Pat. Nos. 6,015,597 (David) and 6,197,120 (David), the disclosures of which are incorporated by reference herein. In some embodiments, surface-treating the porous particles comprises forming a layer comprising silicon, hydrogen, and carbon on at least portion of the external surface of the porous particle by plasma deposition. Forming this layer may be carried out by ionizing a gas comprising an organosilicon compound selected from the group consisting of an alkylsilane, an alkoxysilane, an alkylenepolysilane, an alkylpolysilane, an alkenyl silane, an aryl silane, and combinations thereof. Exemplary alkylsilanes include tetramethylsilane, methylsilane, dimethylsilane, diethylsilane, diethylmethylsilane, propylsilane, trimethylsilane, and ethylsilane. Exemplary alkoxysilanes and siloxanes include tetraethylorthosilicate (TEOS), and tetramethylcyclotetrasiloxane (TMCTS). Exemplary alkylenepolysilanes include disilanomethane, bis(methylsilano)methane, 1,2-disilanoethane, 1,2-bis(methylsilano)ethane, 2,2-disilanopropane, dimethyldisilanoethane, dimethyldisilanopropane, tetramethyldisilanoethane, and tetramethyldisilanopropane. Exemplary alkenylsilanes include vinylmethylsilane and divinyldimethylsilane. Exemplary aryl silanes include phenylsilane, phenyldimethylsilane, and phenyltrimethylsilane. Exemplary alkylpolysilanes include 1,1,2,2-tetramethyldisilane, hexamethyldisilane, 1,1,2,2,3,3-hexamethyltrisilane, and 1,1,2,3,3-pentamethyltrisilane. The organosilicon compound may have substituents such as amino groups, hydroxyl groups, and/or halo (e.g., fluoro, bromo, chloro) groups, although typically they are unsubstituted. In some embodiments, the organosilicon compound has at least one C—H bond, which may be an sp3, sp2 or sp C—H bond. Typically, the organosilicon has a plurality of C—H bonds, for example, at least 2, at least 3, at least 5, at least 9, and/or even at least 12 C—H bonds, or more. Typically useful organosilicon compounds have sufficient vapor pressure under plasma treatment conditions that a plasma is formed.

In some embodiments, surface-treating the porous particles further comprises treating at least a portion of the layer comprising silicon, hydrogen, and carbon with a fluorinated compound (e.g., by plasma treatment or deposition). The fluorinated compound is typically a hydrocarbon in which at least some of the hydrogen atoms are replaced by fluorine atoms. The fluorinated compound may be straight-chained, branched, or cyclic, and may be fully saturated or partially unsaturated. The fluorinated compound typically contains up to 5 carbon atoms (e.g., up to 4, 3, or 2). For plasma deposition, the fluorinated compound typically contains at least 2 or 3 carbon atoms. In some embodiments, the fluorinated compound is perfluorinated (i.e., all C—H bonds are replaced by C—F bonds). In some embodiments, the fluorinated compound is selected from the group consisting of perfluoropropane, carbon tetrafluoride, trifluoromethane, difluoromethane, pentafluoroethane, perfluoropropene, perfluorobutane, and perfluorobutene and combinations thereof.

In some embodiments, surface-treating the porous particles by plasma treatment is done in two steps. For example, a first plasma treatment typically includes treating the porous particle 100 and 200 under vacuum with a gas (e.g., an organosilicon compound as described above) and igniting the plasma. Without intending to be bound by theory, it is believed that when the gas is, for example, tetramethylsilane (TMS), the external surface of the treated porous particle is covered with a layer comprising methyl groups, which provide a hydrophobic external surface. A second plasma treatment, when used, typically includes treating the porous particle under vacuum with a second gas (e.g., a fluorinated compound as described above) and igniting the plasma. Without intending to be bound by theory, it is believed that the second step will replace some of the hydrogens (e.g., C—H bonds) on the surface of the porous particle with fluorine to produce CF, CF₂, or CF₃ groups on the surface. If a depositing fluorochemical plasma is used (e.g., with fluorochemicals having at least 2 or 3 carbon atoms), it is believed that a layer comprising fluorocarbon species is formed on the surface. Each of the two treatment steps may be carried out, for example, for a total of at least 5, 10, 20, 30, 45, or 60 minutes each or longer. Typically, the plasma treatments are carried out at pressures of up to about 1000, 750, 500, 250, 100, or 75 mTorr (133, 100, 67, 33, 13, or 10 Pa).

Plasma treating typically includes mixing the porous particles 100 and 200 to maximize the amount of the outer surface area that is exposed to the plasma. When plasma treatments are carried out on a laboratory scale, the mixing can be carried out by hand. For example, in the two-step process described above each step may be interrupted a number of times (e.g., 2, 3, or 4) to stir the porous particles. The gas is then reintroduced and the plasma reignited. In larger scale treatments, the mixing may be carried out, for example, with a mixing paddle that may continuously rotate during the process.

Plasma treating typically also includes providing a reaction chamber having a capacitively-coupled system comprising at least one grounded electrode and at least one electrode powered by a radio frequency source; generating a plasma comprising reactive species in the chamber causing an ion sheath to form around at least one of the electrodes; and locating a plurality of porous particles in the ion sheath. In some embodiments, the method further comprises agitating the plurality of porous particles in a manner to expose their external surfaces to the reactive species in the plasma.

In the plasma treatments described above, the plasma (e.g., the silane plasma or the fluorine plasma) may include other gaseous component(s), for example, nitrogen or ammonia, as long as the gaseous components don't prevent the external surface from becoming hydrophobic. Thus, the term “gas”, in embodiments wherein a gas is used, refers to a single compound or a mixture of two or more compounds.

Plasma treatment may provide a treated porous particle with a unique structure because it typically treats only the outer surface of the particle. Typically, for the treated porous particles disclosed herein, the pore size is in the range of up to tens of nanometers while the mean free path of the reactive species in the plasma (i.e., the average distance traveled by a species before it collides with another species) is not smaller than 20 microns. Also, plasma deposition methods can form layers of hydrophobic species on a surface. After plasma treatment according to any of the above embodiments, the resulting porous particles with surface hydrophobic groups can be combined with the non-polymeric masking powder (e.g., by dry blending as described above).

In other embodiments, hydrophobic groups can be installed on the outer surfaces of porous particles, for example, by exposing the porous particle 100 and 200 to at least one of water vapor, methanol vapor, or ethanol vapor in a first step and subsequently exposing the porous particle to a second vapor comprising a reactive organosilane compound in a second step. Treating silica surfaces with reactive organosilane compounds is known, for example, in the semiconductor and in printing industries. In semiconductor industry silicon wafers are treated with dichlorodimethylsilane vapor. In printer toner cartridges, silica gel particles treated with dichlorodimethylsilane on both the interior pore surfaces and the external surfaces are used as lubricants. It has been shown in the evaluation of nonporous silica particles that the reaction between dichlorodimethylsilane and the silica surface is enhanced by the presence of surface water. In some embodiments surface-treating the porous particles, the reaction between vapor phase reactive organosilane compounds and a porous particle 100 and 200 has been unexpectedly found to preferentially incorporate hydrophobic groups on the external surface of the porous particle without destroying the adsorbent capacity of the interior pore surfaces of the particle.

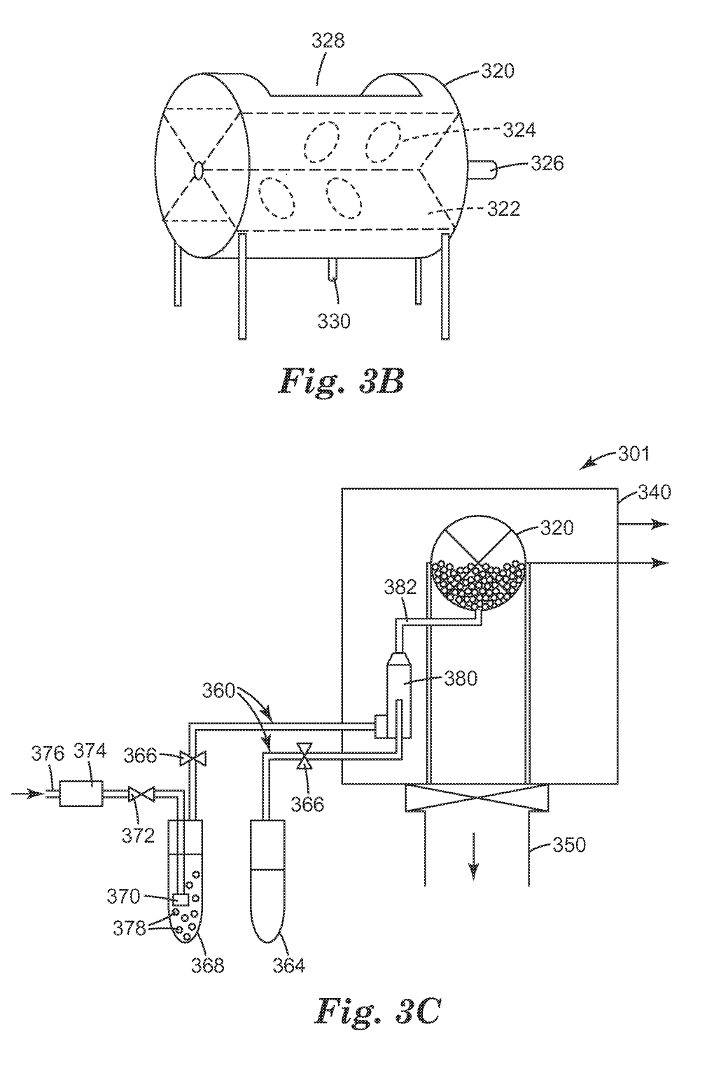

Exposure to at least one of water vapor, ethanol vapor, or methanol vapor in the first step described above can be carried out at ambient pressure (e.g., in a humidity chamber at, for example, 50 to 95 percent relative humidity) or under reduced pressure (e.g., using apparatus 300 shown in FIGS. 3A and 3B) and at ambient temperature or elevated temperature (e.g., in a range from 25° C. to 40° C. or 25° C. to 35° C.). Without wishing to be bound by theory, it is believed that in some embodiments, at least a portion of the water vapor, methanol vapor, or ethanol vapor condenses within at least a portion of the plurality of pores of the porous particles, thereby at least partially occluding the interior pore surfaces. Porous particles 100 and 200 may be dried using conventional drying techniques before the exposure to at least one of water vapor, ethanol vapor, or methanol vapor in the first step. In some embodiments, exposing the porous particles to water vapor is carried out for at least 15, 20, 25, or 30 minutes up to about 1, 2, or 3 hours. Depending on the length of the exposure to water vapor, the porous particles may have different levels of coverage. While non-uniform treatments may result from short exposure times to water vapor, longer exposure times may result in more uniform coverage.

After the first step of exposure to at least one of water vapor, ethanol vapor, or methanol vapor, the porous particles are exposed to the second vapor comprising the reactive organosilane compound to install hydrophobic groups on the outer surface. The reactive organosilane reacts in the areas where the surface water and/or surface silanols are present in particles, and so the uniformity of the hydrophobic groups is influenced by the exposure time to at least one of water, ethanol, or methanol vapor as described above. The time of exposure to the reactive organosilane compound also can affect the amount of hydrophobic groups on the surface. Exposure to a second vapor comprising a reactive organosilane compound in the second step is typically carried out under reduced pressure (e.g., in a range from 0.5 torr to 150 torr (67 Pa to 2×10⁴ Pa) and may be carried out at ambient temperature or elevated temperature (e.g., in a range from 25° C. to 40° C. or 25° C. to 35° C.). In some embodiments, the vapor comprising the reactive organosilane compound is at a pressure of at least 400 Pa, 650 Pa, 1000 Pa, 1300 Pa, or at least 10000 Pa when it comes into contact with the particles. Without intending to be bound by theory, it is believed that a pressure of at least 1000 Pa minimizes the diffusion of the reaction organosilane compound into the pores of the particle so that the treatment remains on the outer surface. Conveniently, a process pressure of 10 torr (1300 Pa) can be used when the vapor pressure of the reactive organosilane compound is above 10 torr (1300 Pa); typically the water vapor, ethanol vapor, or methanol vapor inside the pores of the particles are not pumped out at this pressure.

In either the first step or the second step described above, the porous particles may be agitated in a manner to expose their outer surfaces to at least one of the water vapor, ethanol vapor, methanol vapor, or the second vapor.

The first and second steps described above can be carried out, for example, using apparatus 300 shown in FIGS. 3A and 3B. As shown in FIG. 3A, two liquid holder assemblies 360, one for the reactive organosilane compound and one for water, ethanol, or methanol, can be used to deliver vapor to vacuum chamber 340 connected to vacuum pump 350. The vacuum chamber is typically a hollow cylinder capable of being evacuated to a background pressure of up to 10⁻⁶ ton (10⁻⁴ Pa). Each liquid holder assembly can contain a vacuum compatible glass tube 362, 364 sealed off at one end and an attached valve 366 to control the on/off of the vapor source. If the exposure to water vapor, methanol vapor, or ethanol vapor is carried out, for example, in a humidity chamber as described above, one of the two liquid holder assemblies, which includes tube 362, need not be used. Inside the vacuum chamber 340 is a particle agitator 320 that has an inlet port 330 for the vapor. The second vapor comprising the reactive organosilane compound can be metered into the chamber 340, for example, using a mass flow controllers or needle valves. The mass of reactive organosilane consumed can be monitored using conventional techniques.

A representative particle agitator 320 is shown in more detail in FIG. 3B. Particle agitator 320 is a hollow cylinder with a rectangular opening 328. Agitator 320 is fitted with a shaft 326 aligned with its axis, to which is bolted four rectangular blades 322, which form an agitation mechanism or paddle wheel for the particles in the agitator 320. The blades 322 each contain two holes 324 to promote communication between the particle volumes contained in each of the four quadrants formed by the blades 322 and the agitator cylinder 320. Further details about the method of using of apparatus 300 are described below in the examples.

After treating porous particles with at least one of water vapor, methanol vapor, or ethanol vapor and subsequently with a reactive organosilane according to any of the above embodiments, the resulting porous particles with surface hydrophobic groups can be combined with the non-polymeric masking powder (e.g., by dry blending as described above).

In another embodiment, hydrophobic groups are installed on the outer surfaces of porous particles, for example, by pre-reacting or pre-polymerizing an organosilane in the vapor phase before the vapor reaches the porous particles. By pre-polymerizing the organosilane in the vapor phase to form dimers, trimers, and higher oligomers, the resulting dimers, trimers, and higher oligomers will typically reach a molecular size sufficient to keep the pre-polymerized organosilane from penetrating into the pores of the porous particles. This method may be advantageous, for example, for porous particles having a wide distribution of particle sizes. However, because the dimer, trimer and higher oligomers of some reactive organosilanes have a lower vapor pressure at ambient conditions and will tend to condense on the internal surfaces of the vacuum chamber, it may be necessary to increase the treatment time or otherwise optimize the treatment conditions (e.g. temperature, pressure, and organosilane vapor pressure).

When a reactive organosilane is pre-polymerized before it is combined with porous particles, an alternative method of delivering the organosilane vapor to a vacuum chamber may be advantageously employed. A schematic of one exemplary apparatus 301 for carrying out this method is shown schematically in FIG. 3C. As shown in FIG. 3C, two liquid holder assemblies 360, one for the reactive organosilane compound and one for water, methanol, or ethanol can be used to deliver vapor to vacuum chamber 340. Vacuum chamber 340 is connected to a vacuum pump 350 capable of evacuating the vacuum chamber 340 to a background pressure of about 10⁻⁶ torr (10⁻⁴ Pa) or lower. Inside the vacuum chamber 340 is a particle agitator 320 (which may be as generally shown in FIG. 3B) that has a single inlet port 382.

As shown in FIG. 3C, one liquid holder assembly 360 can contain a vacuum compatible tube 364 sealed off at one end and an attached valve 366 to turn on or off a first vapor source comprising the reactive organosilane compound. A second vapor source can be formed by passing an inert gas (e.g. nitrogen) from a source 376 through a flowrate metering means (e.g. a mass flow controllers 374 and/or needle valves 372) and into a gas dispersion tube 370 immersed in a gas bubbler 368 containing liquid water, methanol, or ethanol, thereby forming bubbles 378 of the inert gas in equilibrium with water, methanol, or ethanol vapor.

The inert gas containing the water, methanol, or ethanol vapor passes into an annular mixing nozzle 380, where it mixes with the organosilane compound before passing into the particle agitator 320 through outlet tube 382, which connects to the inlet tube 330 (see FIG. 3B) of the particle agitator 320. Attached valves 366 may be used to turn on or off the first and second vapor sources. The mass of reactive organosilane consumed can be monitored using conventional mass balance techniques. By passing a known flow rate of nitrogen through the water/methanol bubbler 368 to produce a pre-determined amount at least one of water vapor, methanol vapor, or ethanol vapor or methanol vapor at the annular mixing nozzle 380, it is possible to rapidly polymerize the organosilane monomer to form a higher molecular weight oligomer. By controlling the amount of water, methanol, or ethanol vapor at the annular mixing nozzle 380, desired dimer, trimer or higher oligomer formation can be achieved before the reaction product deposits on the porous particles.

The process parameters for treating porous particles with a pre-polymerized organosilane are similar to those described above for the process of first exposing the porous particles to at least one of water vapor, ethanol vapor, or methanol vapor and subsequently to the reactive silane. In some embodiments, including any of the aforementioned embodiments of these processes, the reactive organosilane compound has a vapor pressure at 25° C. of from 133 Pa to 26,600 Pa. In some embodiments, treating the external surface of the porous particle takes place at a total vapor pressure of from 1,330 Pa to 26,600 Pa. In some embodiments, including any of the aforementioned embodiments of these processes, the porous particles have a median pore size of up to 4 nm, and exposing the porous particle to the vapor comprising the reactive organosilane compound occurs at a total vapor pressure of from 1,330 Pa to 19,950 Pa. In other embodiments, the porous particles have a median pore size of more than 4 nm, and exposing the porous particle to the vapor comprising the reactive organosilane compound occurs at a total vapor pressure of from 6,650 Pa to 26,600 Pa. The latter pressure range may be useful, for example, when the process including first exposing the porous particles to at least one of water vapor, ethanol vapor, or methanol vapor and subsequently to a reactive organosilane is used to treat porous particles having a wide pore size distribution.

After treating porous particles with a pre-poymerized reactive organosilane according to any of the above embodiments, the resulting porous particles with surface hydrophobic groups can be combined with the non-polymeric masking powder (e.g., by dry blending as described above).

In some embodiments, including any of the aforementioned embodiments of the methods described above in which porous particles are exposed to a reactive organosilane compound either after exposure to water vapor, ethanol vapor, or methanol vapor or after the reactive organosilane is pre-polymerized, the reactive organosilane compound is represented by formula RₓSiY₄₋ₓ, wherein each Y is independently a hydrolysable group, which may be selected from the group consisting of halogen (i.e., —F, —Cl, —Br, or —I), alkoxy (e.g., having 1 to 6, 1 to 4, or 1 to 2 carbon atoms), aryloxy (e.g., phenoxy), or acyloxy (e.g., having 1 to 6, 1 to 4, or 1 to 2 carbon atoms), each R is independently alkyl, alkenyl, aryl, arylalkylenyl, or alkylarylenyl, each of which may optionally be substituted (e.g., with cyano or halogen), and x is 1, 2, or 3. In some embodiments, x is 1 or 2. In some embodiments Y is halogen or alkoxy. Typically, Y is chloro. In some embodiments, each R is alkyl (e.g., methyl, ethyl, n-propyl, isopropyl, n-butyl, isobutyl, tert-butyl, n-pentyl, isopentyl, neopentyl, tert-pentyl, n-hexyl, n-heptyl, n-octyl, isooctyl, 2,2,4-trimethylpentyl, n-nonyl, n-decyl, n-dodecyl, n-octadecyl cyclopentyl, cyclohexyl, cycloheptyl, or methylcyclohexyl). In some embodiments, each R is independently methyl, ethyl, or phenyl. In some embodiments, each R is methyl. Exemplary alkenyl groups include vinyl, allyl, and 5-hexene-1-yl. Exemplary aryl groups include phenyl, naphthyl, anthryl, and phenanthryl. Exemplary alkylarylenyl groups include o-, m-, p-tolyl, xylyl and ethylphenyl, and exemplary arylalkylenyl groups include benzyl and alpha- and beta-phenylethyl. Exemplary fluoroalkyl groups include 3,3,3-trifluoro-n-propyl, 2,2,2,2′,2′,2′-hexafluoroisopropyl, 8-heptafluoroisopropyl. Many reactive organosilane compounds represented by formula RₓSiY₄₋ₓ are commercially available (e.g., from Huls America, Inc., Cincinnati, Ohio, and Sigma-Aldrich, St. Louis, Mo.); other organosilane compounds represented by formula RxSiY₄₋ₓ can be prepared according to known methods. In some embodiments, the reactive organosilane compound is selected from the group consisting of dichlorodimethylsilane, dichlorodiethylsilane, trichloromethylsilane, chlorotrimethylsilane, and combinations thereof.

Without intending to be bound by theory it is believed that the reactive organosilane compound represented by formula RₓSiY₄₋ₓ will first undergo hydrolysis with pre-adsorbed surface water to form a silanol. The silanols can undergo condensation reactions with the surface —OH groups and/or other molecules of the reactive organosilane compound to make short polysiloxane units. Polysiloxanes with terminal —OH groups can also react with surface silanol groups through condensation reactions. The R groups from the organosilane compound represented by formula RₓSiY₄₋ₓ on the resulting siloxanes and polysiloxanes render the surface of the treated porous particles hydrophobic.

In some embodiments of any of the methods of surface-treating porous particles described herein, the porous particles can be exposed to a vapor comprising a volatile, non-reactive compound before any of the other surface-treatment steps. At least a portion of the volatile, non-volatile compound may condense within at least a portion of the pores of the porous particles, thereby at least partially occluding the interior pore surfaces. In some of these embodiments, the volatile, non-reactive compound is selected from the group consisting of molecular nitrogen, carbon dioxide, methane, ethane, and combinations thereof. The volatile, non-reactive compound is typically non-reactive with organosilanes that form the hydrophobic siloxanes on at least a portion of the outer surface of the particles. In some embodiments, the condensed volatile, non-reactive compound is removed from the pores after the surface treatment steps (e.g., by heating the particles, exposing the particles to a vacuum, or a combination thereof).

In other embodiments, including any of the foregoing embodiments in which water vapor, ethanol vapor or methanol vapor is introduced into the pores before or during surface treatment, the condensed water vapor, methanol vapor, or ethanol vapor is removed from the pores after the surface treatment steps (e.g., by heating the particles, exposing the particles to a vacuum, or a combination thereof).

In embodiments wherein any component that is introduced into the pores of the porous particles is removed or substantially removed, the interior pores may be essentially the same as those of an untreated porous particle or the starting porous particle before surface treatment. In some embodiments, these interior pore surfaces are hydrophilic. The interior pore surfaces advantageously are available to adsorb odiferous agents, water vapor, or other components.

In some embodiments, including any of the foregoing embodiments of the methods of making porous particles described herein, the method further comprises exposing the porous particles to an acid such as an odor-reducing acid. A porous particle impregnated with an acid may have increased ability, for example, to adsorb ammonia. This odor-reducing acid may be, for example, citric acid, boric acid, salicylic acid, or acetic acid. In some embodiments, the odor-reducing acid is any of the organic acids described above for intercalation into the anionic clay. Such organic acids can render at least a portion of the interior pores of the porous particle hydrophobic. In some of these embodiments, the odor-reducing agent is sebacic acid or stearic acid. Exposing the porous particles to an acid can be carried out by spraying a solution of the odor-reducing agent onto the porous particles and subsequently oven-drying. In some embodiments, the exposure to an acid such as an odor-reducing acid is carried out before any surface treatment or masking powder is introduced. In other embodiments, the exposure to acid can be carried out after surface treatment but before combining the porous particles with the masking powder.

### Absorbent Articles

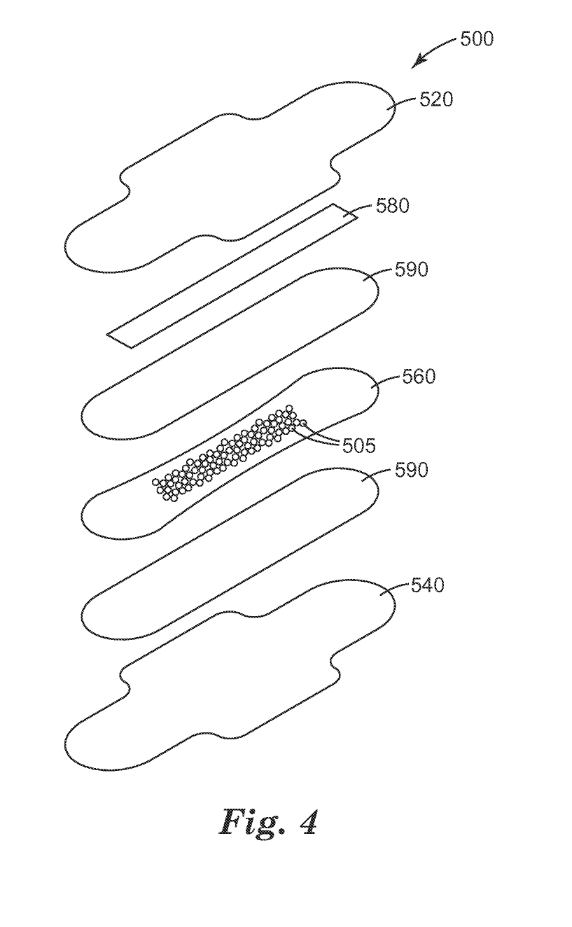

Masked porous particles according to the present disclosure may be useful, for example, as odor-control agents or desiccants incorporated into absorbent articles. Absorbent articles typically have an absorbent component and other structural components particular to how the absorbent article is worn or used. An exemplary absorbent article, sanitary napkin 500, is shown in FIG. 4, but other absorbent articles are contemplated (e.g., an underarm pad, a breast pad, a dress shield, a foot pad, a wound dressing, a diaper, a bed pad or liner, or an incontinence undergarment). In some embodiments, the absorbent article is disposable.

In some embodiments, an absorbent component according to the present disclosure comprises an absorbent material and a plurality of particles comprising the masked porous particle described herein (referred to in some of the following embodiments as a first plurality of particles) in any of the foregoing embodiments. The absorbent material is typically a natural, synthetic, or modified natural organic polymer that can absorb and hold liquids (e.g., aqueous liquids). In some embodiments, the polymer is crosslinked. The term “crosslinked” refers to any means for effectively rendering normally water-soluble materials substantially water insoluble but swellable. Examples of such means include physical entanglement, crystalline domains, covalent bonds, ionic complexes and associations, hydrophilic associations such as hydrogen bonding, and hydrophobic associations or van der Waals forces. Such absorbent materials are usually designed to quickly absorb liquids and hold them, usually without release. The term absorbent material as used herein is not meant to be inclusive of the masked porous particles according to the present disclosure or untreated porous particles. In some embodiments, the absorbent material is usually capable of holding at least about 0.05 gram of liquid per square centimeter, which can be measured by dipping the absorbent material into distilled water, removing the sample from the water, and allowing the sample to drip for 30 seconds. In some embodiments, the absorbent material can absorb at least about 100 percent of its weight in water (e.g., at least 150, 200, 250, 300, 350, or 400 percent) as determined by the Liquid Water Uptake Test Method provided in the Example section, below.

The absorbent component may have any of a number of shapes (e.g., rectangular, I-shaped, or T-shaped). The size and the absorbent capacity of the absorbent component should be compatible with the size of the intended wearer and the liquid loading imparted by the intended use of the absorbent article. Absorbent materials may be zoned and their compositions chosen to move liquids away from the original location of the incoming insult to more remote storage locations. Such a design makes more efficient use of the space in an absorbent article. In some embodiments, the absorbent material is in direct contact with masked porous particles disclosed herein. For example, the masked porous particles can be mixed with superabsorbent polymer (SAP) or wood pulp to be loaded in an absorbent article. In other embodiments, the masked porous particles can be immobilized on a web to be placed in an absorbent article.

In some embodiments of an absorbent component according to the present disclosure and/or a plurality of particles including an absorbent material according to the present disclosure (referred to as a second plurality of particles in some of the following embodiments), the absorbent material is a cellulosic material, SAP, or a mixture thereof. In some embodiments of an absorbent component according to the present disclosure, the absorbent material is an acrylic foam absorbent (e.g., foams described in U.S. Pat. No. 5,817,704 (Shiveley et al.) and the references cited therein, prepared, for example, by polymerization of high internal phase emulsions). In some embodiments, the absorbent component comprises a matrix of hydrophilic fibers (e.g., wood pulp fluff, synthetic meltblown fibers, or combinations thereof) and SAP particles. The SAP particles may be substantially homogeneously mixed with the hydrophilic fibers or may be non-uniformly mixed. Likewise, the absorbent material and the masked porous particles according to the present disclosure may be substantially homogeneously mixed or non-uniformly mixed, for example, in the second plurality of particles. The hydrophilic fibers and superabsorbent particles may be selectively placed into desired zones of the absorbent component to better contain and absorb body exudates. The concentration of the SAP particles may also vary through the thickness of the absorbent component. In some embodiments, the absorbent component comprises a laminate of fibrous webs and SAP or other suitable means of maintaining a superabsorbent material in a localized area.

In some embodiments of an absorbent component according to the present disclosure and/or a plurality of particles including an absorbent material according to the present disclosure (the second plurality of particles), the weight ratio of masked porous particles and the absorbent material is in a range from 0.5:1 to 1:1.5. In some embodiments, amounts of the masked porous particles and the absorbent material are approximately equal (e.g., in a range from 0.9:1 to 1:1.1). However, ratios of the components of the absorbent component may be outside this range for some applications.

In some embodiments (e.g., embodiments of absorbent components or a second plurality of particles disclosed herein) the absorbent material is wood pulp. In some of these embodiments, the absorbent component or second plurality of particles is substantially free of SAP. In other embodiments of an absorbent component or a second plurality of particles disclosed herein, the absorbent particles or fibers comprise SAP. A second plurality of particles comprising the masked porous particles disclosed herein and SAP may be useful, for example, to incorporate into an absorbent article or absorbent component that contains other absorbent materials (e.g., wood pulp). In such a plurality of particles, the ratio of SAP to masked porous particles may be in a range from, for example, 99:1 to 1:99, 95:5 to 5:95, 90:10 to 10:90, 85:15 to 15:85, 80:20 to 20:80, 75:25 to 25:75, or 70:30 to 30:70.

Examples of SAP materials include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrolidone), poly(vinyl morpholinone), poly(vinyl alcohol), and mixtures and copolymers thereof. Further polymers suitable for use in the absorbent component include natural and modified natural polymers, such as hydrolyzed acrylonitrile-grafted starch, acrylic acid grafted starch, methyl cellulose, carboxymethyl cellulose, hydroxypropyl cellulose, and the natural gums (e.g., alginates, xanthum gum, and locust bean gum). Mixtures of natural and wholly or partially synthetic absorbent polymers can also be useful. SAP materials are well known to those skilled in the art and are widely commercially available (e.g., from Evonik Industries, Krefeld, Germany, under the trade designation “FAVOR” or from Stockhausen Corporation of Greensboro, N.C., under the trade designation “FAVOR SXM 880”).

The absorbent material (e.g., SAP) may be in any of a wide variety of geometric forms. In some embodiments, the absorbent material is in the form of discrete particles. However, the absorbent material may also be in the form of at least one of fibers, flakes, rods, spheres, or needles. As a general rule, an absorbent material is present in an absorbent component in an amount of from about 5 to about 90 weight percent based on a total weight of the absorbent component.

In some embodiments, an absorbent article according to the present disclosure comprises a liquid permeable topsheet, a liquid impermeable backsheet, and the absorbent component or the second plurality of particles disclosed in any of the embodiments described above between the topsheet and the backsheet. Such absorbent articles typically include sanitary napkins, diapers, and other incontinence articles. An exploded schematic view of an exemplary embodiment of an absorbent article according to the present disclosure is shown in FIG. 4.

Referring to FIG. 4, in the thickness direction of the absorbent article 500, topsheet 520 is the layer against the user's skin and so the first layer in contact with liquid or other exudate from the user. Topsheet 520 further serves to isolate the user's skin from the liquids held in an absorbent component 560 and typically is compliant, soft feeling, and non-irritating.

Various materials can be useful for forming the topsheet 520 in an absorbent article according to the present disclosure, including apertured plastic films, woven fabrics, nonwoven webs, porous foams, and reticulated foams. In some embodiments, the topsheet is a nonwoven material. Exemplary nonwoven materials include spunbond or meltblown webs of fiber forming polymer filaments (e.g., polyolefin, polyester, or polyamide filaments) and bonded carded webs of natural polymers (e.g., rayon or cotton fibers) and/or synthetic polymers (e.g., polypropylene or polyester fibers). The nonwoven web can be surface treated with a surfactant (e.g., in an amount between about 0.05 and 0.5 weight percent), or otherwise processed to impart the desired level of wettability and hydrophilicity. If a surfactant is used, it can be an internal additive that migrates to the surface or applied to the web by any conventional means (e.g., spraying, printing, dipping, or brush coating).

The backsheet 540 is sometimes referred to as the outer cover and is the farthest layer from the user. The backsheet 540 is typically formed of a thin thermoplastic film (e.g., polyethylene film) which is substantially impermeable to liquid. Backsheet 540 functions to prevent body exudates contained in absorbent component 560 from wetting or soiling the wearer's clothing, bedding, or other materials contacting the diaper. In some embodiments, the backsheet is a polyethylene film having an initial thickness of about 0.5 mil (0.012 millimeter) to about 5.0 mil (0.12 millimeter). The polymer film may be embossed and/or matte finished to provide a more aesthetically pleasing appearance. In some embodiments, backsheet 540 comprises woven or nonwoven fibrous webs that have been constructed or treated to impart the desired level of liquid impermeability. In other embodiments, backsheet 540 comprises laminates formed of a woven or nonwoven fabric and thermoplastic film. In some embodiments, backsheet 540 comprises a vapor or gas permeable microporous “breathable” material that is substantially impermeable to liquid. Backsheet 540 may also serve the function of a mating member for mechanical fasteners, for example, when the backsheet comprises nonwoven fabric.

In some embodiments, absorbent articles according to the present disclosure also comprise an acquisition layer 580, as shown in FIG. 4. The acquisition layer is provided to quickly accept the incoming insult and either absorb, hold, channel, or otherwise manage the liquid so that it does not leak outside the article. The acquisition layer may also be referred to, for example, as a surge layer, intake layer, transfer layer, or transport layer. An acquisition layer is generally capable of handling an incoming insult of between about 60 and 100 milliliters (mL) at an insult volumetric flow rate of from about 5 to 20 mL/second, for infants, for example.

Acquisition layer 580 is typically interposed between topsheet 520 and another layer (e.g., absorbent component 560). The acquisition layer 580 is generally subjacent topsheet 520 at the surface opposite the user's skin. To enhance liquid transfer, it may be desirable to attach the upper and/or lower surfaces of the acquisition layer 580 to the topsheet and the absorbent component 560, respectively. Suitable conventional attachment techniques include at least one of adhesive bonding (e.g., using water-based, solvent-based, or thermally activated adhesives), thermal bonding, ultrasonic bonding, needling, or pin aperturing. If, for example, the acquisition layer 580 is adhesively bonded to the topsheet 520, the amount of adhesive add-on should be sufficient to provide the desired level(s) of bonding, without excessively restricting the flow of liquid from the topsheet 520 into the acquisition layer 580. Various woven and nonwoven webs and foams can be used to construct acquisition layer 580. For example, the acquisition layer 580 may be a nonwoven fabric layer composed of a meltblown or spunbond web of polyolefin filaments. Such nonwoven fabric layers may include conjugate, biconstituent and homopolymer fibers of staple or other lengths and mixtures of such fibers with other types of fibers. The acquisition layer 580 also can be a bonded-carded web or an airlaid web composed of natural and/or synthetic fibers. The bonded-carded web may, for example, be a powder bonded carded web, an infrared bonded carded web, or a through-air bonded carded web. Further examples of surge materials may be found in U.S. Pat. No. 5,490,846 (Ellis et al.) and in U.S. Pat. No. 5,364,382 (Latimer). Acquisition layer 580 may be composed of a substantially hydrophobic material, and the hydrophobic material may optionally be treated with a surfactant or otherwise processed to impart a desired level of wettability and hydrophilicity. In some embodiments, acquisition layer 580 can have a generally uniform thickness and cross-sectional area.

In some embodiments of an absorbent article according to the present disclosure, including the illustrated embodiment in FIG. 4, a substantially hydrophilic tissue sheet 590 is employed to help maintain the integrity, for example, of the airlaid fibrous structure of the absorbent component 560. One or more tissue sheets 590 may be used, or one tissue sheet 590 may wrap around both sides of the absorbent component. The tissue sheet(s) 590 is typically placed about the absorbent component 560 over at least the two major facing surfaces thereof and is composed of an absorbent cellulosic material (e.g., creped wadding or a high wet-strength tissue). In some embodiments, the tissue sheet 590 can be configured to provide a wicking layer, which helps to rapidly distribute liquid over the absorbent material in the absorbent component 560. In these embodiments, the tissue sheet 590 may be considered a distribution layer, which move fluid from the point of initial deposition to the location where storage is desired (e.g., absorbent component 560).

Other types and/or additional distribution layers may be present in the absorbent article. These distribution layers may be made, for example, from woven fabrics and nonwoven webs (e.g., using the materials described above for the topsheet 520 and acquisition layer 580).

In some embodiments of absorbent articles according to the present disclosure, the first plurality of particles 505 including the masked porous particles disclosed herein is located between the topsheet and the absorbent material (e.g., in the absorbent component). In some of these embodiments, including the illustrated embodiment of FIG. 4, the plurality of particles 505 is in direct contact with absorbent material (e.g., of the absorbent component 560). In other of these embodiments, the first plurality of particles 505 may be placed, for example, above the acquisition layer 580 or between the acquisition layer 580 and the tissue layer 590. In some embodiments, the first plurality of particles 505 may be placed, for example, under the absorbent component 560, where they are still effective for odor control, for example. In some embodiments, the absorbent article has an elongated shape, a longitudinal midline, a transverse midline, and a central region at an intersection of the longitudinal and transverse midlines, wherein the plurality of particles is not placed in the central region but is placed on either side of at least one of the longitudinal or transverse midlines. In some embodiments, the absorbent article has an elongated shape, a longitudinal midline, a transverse midline, and a central region at an intersection of the longitudinal and transverse midlines, wherein the plurality of particles is dispersed within the central region. Dispersed can mean, for example, that there is space between the particles.

In some embodiments of the absorbent article, absorbent component, and/or plurality of particles comprising an absorbent material according to the present disclosure, when exposed to aqueous liquid, the plurality of the masked porous particles adsorbs an odiferous agent to a greater extent (e.g., at least 5, 10, 15, 20, 25, 30, 40, or 50 percent better) than a comparative plurality of particles that is the same as the plurality of the masked porous particles except without any masking powder or hydrophobic surface treatment. The comparative plurality of particles has, for example, the same size and pore size distribution as the plurality of masked porous particles and has the same chemical make-up as the masked porous particles before such particles masked and/or provided with a hydrophobic surface treatment. The capacity for the plurality of masked porous particles and the comparative plurality of particles to adsorb odors can be determined, for example, using the Odorant Test Method described in the Examples below, or in a modification of the test method in which an absorbent article is used instead of paper towels. In some of these embodiments, the aqueous liquid is urine (e.g., dog urine as described in the Examples, below.)

While untreated porous particles can be useful for odor control in an absorbent article, untreated porous particles will typically absorb an incoming liquid insult to the absorbent article. The external and interior pore surfaces of the porous particles thereby become less effective for adsorbing odiferous agents in the absorbent article. Furthermore, the black color of certain porous particles (e.g., activated carbon) is typically not desirable in absorbent articles. In contrast to untreated porous particles, the masked porous particles disclosed herein have outer surfaces which generally repel aqueous liquids. They do not absorb as much of the liquid as an untreated particle and therefore have more interior surface area for adsorbing odiferous agents. The masking powder can at least partially cover the outer surface of the porous particle to mask its dark color in some embodiments. The effectiveness of the masked porous particles disclosed herein, particularly in the presence of aqueous liquids, is unexpected given the absence of any polymeric binder that could be used to attach the masking powder to the porous particle.

The absence of a polymeric binder to attach the masking powder to the porous particle also allows for flexibility in manufacturing since the addition of a binder does not need to be considered. For example, the absence of a polymeric binder may allow for dry blending the masking powder and porous particles as described above. In some embodiments, the non-polymeric masking powder is not attached to the outer surface of the porous particle with a binder.

### Selected Embodiments of the Disclosure

In a first embodiment, the present disclosure provides a masked porous particle comprising:

a porous particle with an outer surface; and

a non-polymeric masking powder on at least a portion of the outer surface of the porous particle,

wherein the non-polymeric masking powder is not attached to the outer surface of the porous particle with a polymeric binder, and wherein the masked porous particle has a hydrophobic outer surface.

In a second embodiment, the present disclosure provides the masked porous particle according to the first embodiment, wherein the porous particle is an activated carbon particle.

In a third embodiment, the present disclosure provides the masked porous particle according to the first embodiment, wherein the porous particle is a zeolite particle.

In a fourth embodiment, the present disclosure provides the masked porous particle according to any one of the first, second, or third embodiments, wherein the non-polymeric masking powder is an anionic clay such as a layered double hydroxide.

In a fifth embodiment, the present disclosure provides the masked porous particle according to the fourth embodiment, wherein the anionic clay is intercalated with an organic acid.

In a sixth embodiment, the present disclosure provides the masked porous particle according to the fifth embodiment, wherein the organic acid is a monofunctional or difunctional aliphatic carboxylic acid having at least 6 carbon atoms.

In a seventh embodiment, the present disclosure provides the masked porous particle according to any one of the fourth to sixth embodiments, wherein the anionic clay is a hydrotalcite.

In an eighth embodiment, the present disclosure provides the masked porous particle according to any one of the first, second, or third embodiments, wherein the non-polymeric masking powder is hydrophobic titanium dioxide.

In a ninth embodiment, the present disclosure provides the masked porous particle according to any one of the first, second, or third embodiments, wherein the non-polymeric masking powder is a whitening agent.

In a tenth embodiment, the present disclosure provides the masked porous particle according to the ninth embodiment having an L* value of at least 55.

In an eleventh embodiment, the present disclosure provides the masked porous particle according to any one of the first to tenth embodiments, wherein the porous particle has a surface treatment providing covalently bonded hydrophobic groups on at least a portion of its outer surface, with the non-polymeric masking powder on at least a portion of the treated outer surface.

In a twelfth embodiment, the present disclosure provides the masked porous particle according to the eleventh embodiment, wherein the hydrophobic groups comprise at least one of alkyl or aryl groups, wherein alkyl and aryl are each optionally substituted with fluorine.

In a thirteenth embodiment, the present disclosure provides the masked porous particle according to the eleventh or twelfth embodiment, further comprising interior pore surfaces that are at least partially hydrophilic.

In a fourteenth embodiment, the present disclosure provides the masked porous particle according to any one of the eleventh through thirteenth embodiments, wherein the hydrophobic groups comprise siloxanes having alkyl groups, aryl groups, or combinations thereof.

In a fifteenth embodiment, the present disclosure provides the masked porous particle according to any one of the first through fourteenth embodiments, further comprising an odor-reducing agent within at least some of its pores.

In a sixteenth embodiment, the present disclosure provides the masked porous particle according to any one of the first through fifteenth embodiments, wherein a plurality of the masked porous particles has an adsorption capacity for at least one odiferous agent that is at least 60% of an adsorption capacity of a comparative plurality of porous particles for the odiferous agent, wherein the comparative plurality of porous particles is the same as the plurality of the masked porous particles except without any masking powder or hydrophobic surface treatment.

In a seventeenth embodiment, the present disclosure provides the masked porous particle according to the sixteenth embodiment, wherein the plurality of the masked porous particles has been exposed to an aqueous liquid.

In an eighteenth embodiment, the present disclosure provides the masked porous particle according to any one of the first through sixteenth embodiments, wherein when exposed to aqueous liquid, the plurality of the masked porous particles adsorbs at least one odiferous agent to a greater extent than a comparative plurality of particles that is the same as the plurality of the masked porous particles except without any masking powder or hydrophobic surface treatment.

In a nineteenth embodiment, the present disclosure provides a first plurality of particles comprising the masked porous particle according to any one of the first through eighteenth embodiments.

In a twentieth embodiment, the present disclosure provides the first plurality of particles according to the nineteenth embodiment, wherein the first plurality of particles is substantially free of particles wherein the external surface and the interior pore surfaces are both treated with hydrophobic groups.

In a twenty-first embodiment, the present disclosure provides a second plurality of particles comprising the masked porous particle of any one of the first to eighteenth embodiments and at least one of superabsorbent polymers, hydrophilic nonwovens, or wood pulp.

In a twenty-second embodiment, the present disclosure provides an absorbent component comprising an absorbent material in combination with the first plurality of particles according to the nineteenth or twentieth embodiment.

In a twenty-third embodiment, the present disclosure provides an absorbent component according to the twenty-second embodiment, wherein the absorbent material is at least one of wood pulp, a superabsorbent polymer, or an acrylic foam.

In a twenty-fourth embodiment, the present disclosure provides an absorbent article comprising the first plurality of particles according to the nineteenth or twentieth embodiment.

In a twenty-fifth embodiment, the present disclosure provides an absorbent article comprising a liquid permeable topsheet, a liquid impermeable backsheet, and the absorbent component according to the twenty-second or twenty-third embodiment between the topsheet and the backsheet.

In a twenty-sixth embodiment, the present disclosure provides the absorbent article according to the twenty-fourth or twenty-fifth embodiment, wherein the first plurality of particles is located between the topsheet and the absorbent material.

In a twenty-seventh embodiment, the present disclosure provides an absorbent article comprising a liquid permeable topsheet, a liquid impermeable backsheet, and the second plurality of particles according to the twenty-first embodiment between the topsheet and the backsheet.

In twenty-eighth embodiment, the present disclosure provides the absorbent article according to any one of the twenty-fourth to twenty-seventh embodiments, wherein the absorbent article has an elongated shape, a longitudinal midline, a transverse midline, and a central region at an intersection of the longitudinal and transverse midlines, and wherein the first or second plurality of particles is not placed in the central region but is placed on either side of at least one of the longitudinal or transverse midlines.

In a twenty-ninth embodiment, the present disclosure provides the absorbent article according to any one of the twenty-fourth to twenty-seventh embodiments, wherein the absorbent article has an elongated shape, a longitudinal midline, a transverse midline, and a central region at an intersection of the longitudinal and transverse midlines, and wherein the first or second plurality of particles is dispersed within the central region.

In a thirtieth embodiment, the present disclosure provides a method of making a masked porous particle according to any one of the first to seventeenth embodiments, the method comprising:

providing a porous particle; and

dry blending the non-polymeric masking powder with the porous particle to provide the masked porous particle.

In a thirty-first embodiment, the present disclosure provides the use of a masked porous particle according to any one of the first to seventeenth embodiments or the plurality of particles according to any one of the eighteenth to twentieth embodiments as an odor-control agent.

In a thirty-second embodiment, the present disclosure provides the use of a masked porous particle according to the thirty-first embodiment, wherein the odor-control agent is exposed to aqueous liquids.

In a thirty-third embodiment, the present disclosure provides the use of a masked porous particle according to the thirty-first or thirty-second embodiment, wherein the odor-control agent is in an absorbent article.

Embodiments of this disclosure are further illustrated by the following non-limiting examples, but the particular materials and amounts thereof recited in these examples, as well as other conditions and details, should not be construed to unduly limit this disclosure.

### EXAMPLES

### Test Methods

### Color Measurement Test

The color measurement values of L*, a*, and b* values established by the CIE (Commision Internationale de l'Eclairge) were determined using a Microflash Model No. 100 spectrophotometer (Datacolor International, Lawrenceville, N.J.). The spectrophotometer was calibrated with a standard white background (Datacolor International white calibration standard serial no. 2508 comprising pressed polytetrafluoroethylene (PTFE) powder) as a reflectance standard. Each sample was spread on a white sheet of paper and was pressed with a glass plate so as to be relatively flat. Each sample was at least about 5 mm in thickness and sufficiently large in size to essentially completely cover the opening of the spectrophotometer (so that the measured reflectance would be that of the sample rather than that of the background sheet of paper). Total reflectance measurements were made on each sample in at least 3 different locations using a d/8 degree geometry (diffuse hemispherical illumination with an 8 degree viewing angle) and were averaged. The spectrophotometer provided lightness values (L*) from 0 to 100 (with a value of 0 being black and 100 being white), chromaticity coordinate values for a* from −60 to +60 (with −60 being green and +60 being red), and chromaticity coordinate values for b* from −60 to +60 (with −60 being blue and +60 being yellow).

### Carbon Tetrachloride Activity (CTA) Test

Carbon tetrachloride activity of the sample was tested according to ASTM D3467. Activity was determined by flowing CCl₄-laden air through a sample of known weight and volume, under the specified conditions, until there was no further increase in the weight of the sample, then determining the weight of the CCl₄ adsorbed.

### Apparent Density of Activated Carbon Test

The apparent density (bulk density) of activated carbon measurement was determined on a granular sample according to ASTM D2854.

### Moisture Uptake Test

Moisture absorption was measured for the treated and untreated porous particles. Two grams of sample were weighed into a 57 mm diameter aluminum pan and then exposed to a controlled environment of 35° C., 80% relative humidity. The weight gain after 3 hours exposure in the humidity chamber was reported using the following equation where g/g represents grams/gram:

moisture uptake (g/g)=(sample weight at 3 hrs−initial sample weight)/(initial sample weight)

### Liquid Water Uptake Test

A porous frit filter was fitted to a conical flask with a side arm. The side arm was connected to house vacuum. A 90 mm diameter #54 filter paper was placed on the frit and then wet with water followed by vacuum to dry. Sample particles (2 g) were placed on the filter paper, and 10 mL of deionized water was added along the walls of the frit glass. The water was allowed to stand for 3 minutes in contact with the particles. After 3 minutes, vacuum was applied through the side arm until no water was observed to be coming through the frit and into the collecting flask, and the wet particles were removed from the filter paper and weighed. The water uptake value was then calculated using the following equation:

water uptake (g/g)=(sample wet weight−sample dry weight)/(sample dry weight)

The procedure was repeated three times for each sample. The average water uptake was reported where g/g represents grams/gram.

### X-ray Diffraction Test for the Identification of Intercalated Clays

Samples were prepared as fine powders and applied to glass microscope slides on which double coated tape had been applied. The sample powder was pressed into the tape adhesive with a metal spatula to produce a thin flat uniform layer suitable for scanning Reflection geometry X-ray diffraction data were collected by use of a Huber 4-circle diffractometer (Huber Diffraktionstechnik Gmbh & Co. KG., Rimsting, Germany), copper K_{α} radiation, and scintillation detector registry of the scattered radiation. The incident beam was collimated to a 700 μm an pinhole and filtered by a nickel foil. Data were collected in the form of a (θ/2θ) step-scan from 0.5 to 15 degrees (2θ) using a 0.02 degree step size and 20 second count time per step. Generator settings for the sealed tube X-ray source were 40 kV and 20 mA. Huber 4-circle diffractometer motor control and data acquisition was conducted using SPEC (version 5.02, Certified Scientific Software, Cambridge, Mass.) software on a Linux computer platform. Analysis of resulting diffraction data was performed using Jade (version 9, Materials Data Inc., Livermore, Calif.) software.

### pH Evaluation

Ten grams of sample particles were added to 200 mL of deionized water and soaked for at least 6 hours. The solution was heated to 80° C. on a hot plate for 30 minutes and then allowed to cool to room temperature. The solution was filtered, and the pH of the filtrate was measured using a pH meter.

### Odorant Test

A round 45 mm plastic vial cap was used as a sample container. A flat, circular paper towel insert (43 mm in diameter; prepared from WypAll L30 toweling and obtained from Kimberly Clark Corporation, Neenah, Wis.) was placed in the bottom of the sample container. The porous particle sample (0.5 g) was placed on the paper towel and covered with a top sheet of paper towel (43 mm in diameter). The sample container was then placed inside an 8 ounce wide mouth jar. Dog urine (2.0 mL) was added dropwise to the top sheet of paper towel. The jar was sealed with two layers of Parafilm (available from VWR Scientific, Radnor, Pa.) and the lid to the jar was secured. After 24 hours at 38° C., the lid of the jar was removed and a small slit was cut into the Parafilm seal to allow for measurement of odorant by insertion of a Draeger detection tube for ammonia (obtained from Draeger Safety Inc., Pittsburg, Pa.) or a GasTec detection tube for amines (obtained from GasTec Corporation, Ayase-Shi, Kanagawa, Japan). The level of odorant was measured in ppm and also reported as the percent reduction in odorant level relative to the measurement being determined without any porous particles present.

The same general procedure was utilized with ammonium hydroxide used as the odorant with the following modifications. Ammonium hydroxide solution (0.75 microliters of a 10% aqueous solution) was added by pipette against the inner wall of the wide mouth jar to make sure that the solution did not touch the porous particle sample and 0.25 g of porous particle sample was used. The jar was sealed with two layers of Parafilm and the lid to the jar was secured. After 30 minutes at 20° C., the lid was removed and a small slit was cut into the Parafilm to allow for measurement of odorant by insertion of a Draeger ammonia detection tube.

The dog urine was obtained from beagle dogs housed in an AAALAC accredited facility. Fresh samples were collected immediately after urination and stored in a refrigerator. All procedures were conducted in accordance with an approved Institutional Animal Care and Use Committee (IACUC) protocol.

The term ‘odorant only’ is used when the test is conducted without any porous particles added to the test container.

### Example 1

Coconut based Kuraray Coal GG activated carbon (1350 g of 12×20 mesh, 1.7 mm to 0.85 mm) (Comparative Example 1), obtained from Kuraray Chemical, Osaka, Japan, was sprayed with approximately 500 g of deionized water. The as-received Comparative Example 1 had a 5.2 weight percent water content. After the water treatment, the wet sample had a 30 weight percent water content. The wet carbon particles and the as-received particles (Comparative Example 1) both had the same free flowing characteristics as determined by visual inspection.

The wet carbon particles (1850 g) were loaded into a 1 gallon particle agitator (FIG. 3B) contained in the apparatus 300 shown in FIG. 3A and treated with dichlorodimethylsilane (DDMS) (obtained from Gelest Inc., Morrisville, Pa.) according to the method below.

The particle agitator 320 consisted of a hollow cylinder (30.5 cm long×17.8 cm diameter horizontal) with a rectangular opening (28.6 cm×16.5 cm) in the top. The agitator was fitted with a shaft 326 aligned with its axis. The shaft had a rectangular cross section to which was bolted four rectangular blades 322 (29.8 cm by 8.9 cm) forming an agitation mechanism or paddle wheel for the particles being tumbled. The blades contained two holes 324 to promote communication between the particle volumes contained in each of the four quadrants formed by the blades and agitator cylinder. The dimensions of the blades were selected to give side and end gap distances of 4 mm with the agitator walls. The particle agitator had a gas inlet port 330 at the bottom of the cylinder and the particle agitator 320 was placed in a vacuum chamber 340 connected to a mechanical pump 350.

Vacuum compatible glass tubes 362, 364 sealed off at one end were used to deliver DDMS vapor from the liquid source to the vacuum chamber. Additional valves 366 were attached to control the on/off of the vapor source. The chamber was evacuated to 10 Torr (1.3×10³ Pa). The agitator power was turned on to rotate the paddles at 4 rotations per minute (rpm). The DDMS vapor valve was opened and the vapor was fed through a mass flow controller (obtained from MKS instruments, Andover, Md.) at a controlled rate of 0.65 g/min. The treatment was carried out for 60 minutes. The chamber pressure was kept between 10 to 20 Torr (1.3×10³ to 2.6×10³ Pa) during the process. At the end of 60 minutes, the DDMS vapor valve and mass flow controller were both closed. The chamber was evacuated using a vacuum pump for a few minutes and then purged with nitrogen before venting to atmospheric conditions. The DDMS treated carbon particles (approximately 850 g) were dried overnight at 140° C. to remove residual water content from DDMS treated carbon particles (providing Comparative Example 2). The amount of DDMS used (39.1 g) was determined from the initial and final weights of the DDMS holder.

Two “V”-shaped blenders (obtained from Patterson-Kelley, East Stroudsburg, Pa.) were used to dry mix white synthetic hydrotalcite (Mg₆Al₂(OH)₁₆]CO₃*4H₂O; CAS Number 11097-59-9; obtained from Sigma-Aldrich Company, St. Louis, Mo.) with Comparative Example 2. Mixtures containing Comparative Example 2 (300 g) and hydrotalcite (85 g) were loaded into each chamber of the twin ‘V’ blender. Both blenders were tumbled at the rate of 20-22 rpm for 3 hours. The dry coating of white hydrotalcite powder on the surface of Comparative Example 2 provided the new product Example 1. The color of the different samples was measured using the spectrophotometer obtained from Datacolor International according to the test method described above. These results are presented in Table 1 with the value of ‘L*’ indicating the degree of whiteness of the sample. Comparative Examples 1-2 and Example 1 were tested for carbon tetrachloride (CCl₄) activity (CTA test) and apparent density using the test methods described above. The results are presented in Table 2.

TABLE 1
Color coordinates of the particles

| | L* | a* | b* |
|---|---|---|---|
| Comparative Example 1 | 18.48 | 0.83 | 1.33 |
| Comparative Example 2 | 17.77 | 0.65 | 1.06 |
| Hydrotalcite (powder) | 100 | 0.20 | 0.16 |
| Example 1 | 80.35 | −1.38 | −2.70 |

TABLE 2

| | | CCl₄ Activity | |
|---|---|---|---|
| | | (test method ASTM D3467) | |
| | Apparent Density | weight basis | volume basis |
| | (test method ASTM | (g CCl₄/g | (g CCl₄/mL |
| Sample | D2854) | sample) × 100 | sample) × 100 |
| Comparative | 0.441 g/mL | 82.0% | 36.2% |
| Example 1 | | | |
| Comparative | 0.454 g/mL | 76.0% | 34.5% |
| Example 2 | | | |
| Example 1 | 0.471 g/mL | 60.9% | 28.7% |

### Example 2

Intercalation of hydrotalcite with stearic acid was accomplished by mixing 100 g of hydrotalcite with 150 g of stearic acid powder (obtained from Avantor Performance Materials, Phillipsburg, N.J.). The mixing was done in a “V”-shaped blender (obtained from Patterson-Kelley) for 1 hour at 20 rpm. After 1 hour, the mixed powder was removed and heated in a convection oven at 90° C. for 6 hours. The mixture was then cooled to room temperature. The stearic acid intercalated hydrotalcite was characterized by X-ray diffraction. X-ray diffraction peaks corresponding to 49.0 Å, and 16.3 Å, and the absence of a stearic acid peak at 40.0 Å provided evidence that the stearic acid was intercalated in the hydrotalcite.

### Example 3

Intercalation of hydrotalcite with sebacic acid was accomplished by mixing 100 g of hydrotalcite with 33.5 g of sebacic acid powder (obtained from Sigma-Aldfich). The mixing was done in a “V”-shaped blender (obtained from Patterson-Kelley) for 1 hour at 20 rpm. After 1 hour the mixed powder was removed and heated in a convection oven at 150° C. for 6 hours. The mixture was then cooled to room temperature. The sebacid acid intercalated hydrotalcite was characterized by X-ray diffraction. An X-ray diffraction peak corresponding to 19.3 Å confirmed that the sebacic acid was intercalated in the hydrotalcite.

### Example 4

Kuraray Coal GC activated carbon (100 g of mesh size 30×60, 0.6 mm to 0.25 mm) (Comparative Example 3) was coated with sebacic acid intercalated hydrotalcite powder (25 g of Example 3) by physical tumbling in a “V”-shaped blender (Patterson-Kelley). The tumbling was carried out for 1 hour at a 20 rpm. After 1 hour, the white powder coated carbon particles were removed from the blender and sieved using a 60 mesh screen to remove fines from the coating. The color, liquid water uptake, and moisture uptake measurements for Comparative Example 3 and Example 4 were conducted according to the test methods described above and the results are presented in Table 3. Odorant testing using dog urine was conducted according to the procedures described above and the results for Comparative Example 3 and Example 4 are presented in Table 4.

### Example 5

Comparative Example 4 was prepared by treating Kuraray Coal GC activated carbon (100 g of mesh size 30×60, 0.6 mm to 0.25 mm) (Comparative Example 3) with DDMS chemical vapor deposition using the procedure described in Example 1. Sebacic acid intercalated hydrotalcite powder (25 g of Example 3) was mixed with Comparative Example 4 according to the procedure described in Example 4. After 1 hour of tumbling at 20 rpm, the white powder coated carbon particles were removed from the blender and sieved using a 60 mesh screen to remove fines from the coating. The color, liquid water uptake, and moisture uptake measurements for Comparative Example 4 and Example 5 were conducted according to the test methods described above and the results are presented in Table 3. Odorant testing using dog urine was conducted according to the procedure described above and the results for Comparative Example 4 and Example 5 are presented in Table 4.

TABLE 3

| | | | | Water uptake | Moisture uptake |
|---|---|---|---|---|---|
| Sample | L* | a* | b* | (g/g) | (g/g) |
| Comparative | 41.22 | 0.22 | 1.97 | 0.74 | 0.47 |
| Example 3 | | | | | |
| Comparative | 41.63 | 0.24 | 1.94 | 0.61 | 0.35 |
| Example 4 | | | | | |
| Example 4 | 63.24 | −0.50 | −1.71 | 0.32 | 0.40 |
| Example 5 | 67.51 | −0.49 | −1.56 | 0.18 | 0.28 |

TABLE 4

Ammonia
(Drager test)

| Sample | ppm | % reduction |
|---|---|---|
| odorant only | 50 | |
| Comparative | 37 | 26 |
| Example 3 | | |
| Comparative | 25 | 50 |
| Example 4 | | |
| Example 4 | 18 | 64 |
| Example 5 | 30 | 40 |

### Example 6

Kuraray Coal GG activated carbon (100 g of mesh size 30×60, 0.6 mm to 0.25 mm) (Comparative Example 5) was treated with DDMS chemical vapor deposition using the procedure described in Example 1 to provide Comparative Example 6. Sebacic acid intercalated hydrotalcite powder (25 g of Example 3) was mixed with Comparative Example 6 according to the procedure described in Example 4. After 1 hour of tumbling at 20 rpm, the white powder coated carbon particles were removed from the blender and sieved using a 60 mesh screen to remove fines from the coating. The color, liquid water uptake, and moisture uptake measurements for Comparative Example 5 and Example 6 were conducted according to the test methods described above and the results are presented in Table 5. Odorant testing using an ammonium hydroxide solution as the odorant was conducted according to the procedure described above and the results for Comparative Example 5 and Example 6 are presented in Table 6.

### Example 7

Kuraray Coal GG activated carbon (100 g of mesh size 30×60, 0.6 mm to 0.25 mm) (Comparative Example 5) was treated with DDMS chemical vapor deposition using the procedure described in Example 1 to provide Comparative Example 6. Stearic acid intercalated hydrotalcite powder (25 g of Example 2) was mixed with Comparative Example 6 according to the procedure described in Example 4. After 1 hour of tumbling at 20 rpm, the white powder coated carbon particles were removed from the blender and sieved using a 60 mesh screen to remove fines from the coating. The color, liquid water uptake, and moisture uptake measurements for Comparative Example 5 and Example 7 were conducted according to the test methods described above and the results are presented in Table 5. Odorant testing using ammonia was conducted according to the procedure described above and the results for Comparative Example 5 and Example 6 are presented in Table 6.

TABLE 5

| | | | | Water uptake | Moisture uptake |
|---|---|---|---|---|---|
| Sample | L* | a* | b* | (g/g) | (g/g) |
| Comparative | 42.19 | 0.24 | 2.01 | 0.79 | 0.41 |
| Example 5 | | | | | |
| Example 6 | 66.73 | −0.45 | −1.45 | 0.23 | 0.29 |
| Example 7 | 57.57 | −0.49 | −1.48 | 0.30 | 0.32 |

TABLE 6

Ammonia
(Drager test)

| Sample | ppm | % reduction |
|---|---|---|
| odorant only | 900 | |
| Comparative | 400 | 56 |
| Example 5 | | |
| Example 6 | 125 | 86 |
| Example 7 | 32 | 96 |

### Example 8

Citric acid monohydrate (5.25 g, obtained from Alfa Aesar, Ward Hill, Mass.) was dissolved in deionized water (160 g) and the solution was sprayed on 200 g of Kuraray Coal GC activated carbon, mesh size 30×60 (0.6 mm to 0.25 mm) (Comparative Example 3). The wet sample was then placed in an oven at 120° C. for 6 hours to provide dried activated carbon impregnated with citric acid. Sebacic acid intercalated hydrotalcite powder (50 g of Example 3) and 200 g of the dried activated carbon impregnated with citric acid were added to a “V”-shaped blender (obtained from Patterson-Kelley) and tumbled for 1 hour at 20 rpm. The white powder coated carbon particles were removed from the blender and sieved using a 60 mesh screen to remove fines from the coating. The color, liquid water uptake, moisture uptake, and pH measurements for Comparative Example 3 and Example 8 were conducted according to the test methods described above and the results are presented in Table 7. Odorant testing using dog urine was conducted according to the procedure described above and the results for Comparative Example 3 and Example 8 are presented in Table 8.

### Example 9

Ascorbic acid (4.4 g, obtained from Alfa Aesar) was dissolved in deionized water (160 g) and the solution was sprayed on 200 g of Kuraray Coal GC activated carbon, mesh size 30×60 (0.6 mm to 0.25 mm) (Comparative Example 3). The wet sample was then placed in an oven at 120° C. for 6 hours to provide dried activated carbon impregnated with ascorbic acid. Sebacic acid intercalated hydrotalcite powder (50 g of Example 3) and 200 g of the dried activated carbon impregnated with boric acid were added to a “V”-shaped blender (obtained from Patterson-Kelley) and tumbled for 1 hour at 20 rpm. The white powder coated carbon particles were removed from the blender and sieved using a 60 mesh screen to remove fines from the coating. The color, liquid water uptake, moisture uptake, and pH measurements for Comparative Example 3 and Example 9 were conducted according to the test methods described above and the results are presented in Table 7. Odorant testing using dog urine was conducted according to the procedure described above and the results for Comparative Example 3 and Example 9 are presented in Table 8.

### Example 10

Salicylic acid (3.45 g, obtained from Sigma-Aldrich) was dissolved in deionized water (160 g) and the solution was sprayed on 200 g of Kuraray Coal GC activated carbon, mesh size 30×60 (0.6 mm to 0.25 mm) (Comparative Example 3). The wet sample was then placed in an oven at 120° C. for 6 hours to provide dried activated carbon impregnated with salicylic acid. Sebacic acid intercalated hydrotalcite powder (50 g of Example 3) and 200 g of the dried activated carbon impregnated with salicylic acid were added to a “V”-shaped blender (obtained from Patterson-Kelley) and tumbled for 1 hour at 20 rpm. The white powder coated carbon particles were removed from the blender and sieved using a 60 mesh screen to remove fines from the coating. The color, liquid water uptake, moisture uptake, and pH measurements for Comparative Example 3 and Example 10 were conducted according to the test methods described above and the results are presented in Table 7. Odorant testing using dog urine was conducted according to the procedure described above and the results for Comparative Example 3 and Example 10 are presented in Table 8.

### Example 11

Sebacic Acid (5.05 g, obtained from Sigma-Aldrich) was dry blended with 200 g of Kuraray Coal GC activated carbon, mesh size 30×60 (0.6 mm to 0.25 mm) (Comparative Example 3) in a V-shaped blender (obtained from Patterson-Kelley). The mixing was carried out for 1 hour at 20 rpm. The sample was then placed in an oven at 120° C. for 6 hours to provide activated carbon impregnated with sebacic acid. Sebacic acid intercalated hydrotalcite powder (50 g of Example 3) and 200 g of the dried activated carbon impregnated with sebacic acid were added to the V-shaped blender and tumbled for 1 hour at 20 rpm. The white powder coated carbon particles were removed from the blender and sieved using a 60 mesh screen to remove fines from the coating. The color, liquid water uptake, moisture uptake, and pH measurements for Comparative Example 3 and Example 11 were conducted according to the test methods described above and the results are presented in Table 7. Odorant testing using dog urine was conducted according to the procedure described above and the results for Comparative Example 3 and Example 11 are presented in Table 8.

TABLE 7

| | | | | Water | Moisture | |
|---|---|---|---|---|---|---|
| Sample | L* | a* | b* | uptake (g/g) | uptake (g/g) | pH |
| Comparative | 41.22 | 0.22 | 1.94 | 0.74 | 0.47 | 6.67 |
| Example 3 | | | | | | |
| Example 8 | 62.00 | −0.50 | −0.98 | 0.40 | 0.41 | 6.92 |
| Example 9 | 61.69 | −0.48 | −0.90 | 0.43 | 0.40 | 6.85 |
| Example 10 | 61.52 | −0.53 | −1.08 | 0.36 | 0.39 | 6.75 |
| Example 11 | 63.03 | −0.52 | −1.17 | 0.34 | 0.39 | 6.87 |

TABLE 8

Ammonia
(Drager test)

| Sample | ppm | % reduction |
|---|---|---|
| odorant only | 70 | |
| Comparative | 40 | 43 |
| Example 3 | | |
| Example 8 | 25 | 64 |
| Example 9 | 18 | 74 |
| Example 10 | 25 | 64 |
| Example 11 | 21 | 70 |

### Example 12

Kuraray Coal GC activated carbon (100 g of mesh size 30×60) (0.6 mm to 0.25 mm) (Comparative Example 3) was coated with 25 g of hydrophobic titanium dioxide (available as product number R420 from Sachtleben Chemie GmbH, Duisburg, Germany) by physical tumbling in a “V”-shaped blender (Obtained from Patterson-Kelley). The R420 hydrophbic titanium dioxide (TiO₂) is a silica-zirconia treated hydrophobic TiO₂ with a mean particle size of 200 nm. The tumbling was carried out for 1 hour at a 20 rpm. After 1 hour the white powder coated carbon particles were removed from the blender and sieved using a 60 mesh screen to remove fines from the coating. The color, liquid water uptake, and moisture uptake measurements for Comparative Example 3 and Example 12 were conducted according to the test methods described above and the results are presented in Table 9. Odorant testing using dog urine was conducted according to the procedure described above, and the results for Comparative Example 3 and Example 12 are presented in Table 10.

### Example 13

Wood-based activated carbon 100 g of mesh size 30×60) (Comparative Example 7, obtained from Meadwestvaco Corp., Richmond, Va.) was coated with 25 g of hydrophobic titanium dioxide (available as product number R420 from Sachtleben Chemie GmbH, Duisburg, Germany) by physical tumbling in a “V”-shaped blender (obtained from from Patterson-Kelley). The R420 hydrophbic titanium dioxide (TiO₂) is a silica-zirconia treated hydrophobic TiO₂ with a mean particle size of 200 nm. The tumbling was carried out for 1 hour at a 20 rpm. After 1 hour the white powder coated carbon particles were removed from the blender and sieved using a 60 mesh screen to remove fines from the coating. The color, liquid water uptake, and moisture uptake measurements for Comparative Example 7 and Example 13 were conducted according to the test methods described above, and the results are presented in Table 9. Odorant testing using dog urine was conducted according to the procedure described above, and the results for Comparative Example 7 and Example 13 are presented in Table 10.

TABLE 9

| | | | | Water uptake | Moisture uptake |
|---|---|---|---|---|---|
| Sample | L* | a* | b* | (g/g) | (g/g) |
| Comparative | 41.22 | 0.22 | 1.97 | 0.74 | 0.47 |
| Example 3 | | | | | |
| Example 12 | 68.12 | −1.4 | −2.2 | 0.70 | 0.38 |
| Comparative | 42.05 | 0.21 | 1.87 | 1.36 | — |
| Example 7 | | | | | |
| Example 13 | 61.22 | −0.94 | −0.94 | 1.19 | 0.24 |

TABLE 10

Ammonia
(Drager test)

| Sample | ppm | % reduction |
|---|---|---|
| odorant only | 95 | |
| Comparative | 50 | 47 |
| Example 3 | | |
| Example 12 | 40 | 58 |
| Comparative | 80 | 16 |
| Example 7 | | |
| Example 13 | 66 | 31 |

### Example 14

Wood-based activated carbon (100 g of mesh size 30×60) (0.6 mm to 0.25 mm) (Comparative Example 7, obtained from Meadwestvaco Corp) was coated with sebacic acid intercalated hydrotalcite powder (25 g of Example 3) by physical tumbling in a “V”-shaped blender (obtained from Patterson-Kelley). The tumbling was carried out for 1 hour at a 20 rpm. After 1 hour the white powder coated carbon particles were removed from the blender and sieved using a 60 mesh screen to remove fines from the coating. The color and water uptake measurements for Comparative Example 7 and Example 14 were conducted according to the test methods described above, and the results are presented in Table 11. Odorant testing using dog urine was conducted according to the procedure described above, and the results for Comparative Example 7 and Example 14 are presented in Table 12.

TABLE 11

| | | | | Water uptake |
|---|---|---|---|---|
| Sample | L* | a* | b* | (g/g) |
| Comparative | 42.05 | 0.21 | 1.87 | 1.36 |
| Example 7 | | | | |
| Example 14 | 59.67 | −0.24 | −0.27 | 0.45 |

TABLE 12

| | |
|---|---|
| Ammonia | Amines |
| (Drager test) | (GasTec test) |

| Sample | ppm | % reduction | ppm | % reduction |
|---|---|---|---|---|
| odorant only | 50 | | >100 | |
| Comparative | 50 | 0 | >100 | — |
| Example 7 | | | | |
| Example 14 | 18 | 64 | 80 | >20 |

### Examples 15-20

In Examples 15-20, coconut based Kuraray Coal GG12/20 activated carbon (1.7 mm to 0.85 mm) (Comparative Example 1) was treated with varying amounts of DDMS and hydrotalcite according to the procedure described in Example 1. The DDMS treatment level was determined by the following equation: [(grams of DDMS based on weight loss of the reactant/grams of carbon)×100]. In Examples 15-20, varying amounts of hydrotalcite on the coated particles were measured as weight percent of hydrotalcite on the particles. The levels of DDMS treatment and hydrotalcite coating for Examples 15-20 are shown in Table 13. In Comparative Examples 8 and 9, no hydrocalcite was coated on the particles. The color and carbon tetrachloride activity (CTA) tests were conducted according to the test methods described above, and the results are presented in Table 14.

TABLE 13

| | | Hydrotalcite |
|---|---|---|
| | DDMS | Treatment Level |
| | Treatment | [weight % |
| Sample | Level | of hydrotalcite] |
| Comparative | 0% | 0% |
| Example 1 | | |
| Comparative | 5% | 0% |
| Example 8 | | |
| Comparative | 11% | 0% |
| Example 9 | | |
| Example 15 | 5% | 10% |
| Example 16 | 5% | 20% |
| Example 17 | 5% | 30% |
| Example 18 | 10% | 10% |
| Example 19 | 10% | 20% |
| Example 20 | 10% | 30% |

TABLE 14

| | Carbon | |
|---|---|---|
| | Tetrachloride | |
| | Activity | |
| Sample | (weight basis) | L* |
| Comparative | 83.0% | 18.48 |
| example 1 | | |
| Comparative | 75.0% | — |
| example 8 | | |
| Comparative | 67.2% | — |
| example 9 | | |
| Example 15 | 68.8% | 68.90 |
| Example 16 | 61.9% | 77.54 |
| Example 17 | 53.2% | 79.41 |
| Example 18 | 64.6% | 69.80 |
| Example 19 | 55.5% | 74.76 |
| Example 20 | 50.7% | 76.31 |

### Example 21

Example 21 was carried out using the method described in Example 1 except with the following modifications.

Two “V”-shaped blenders (obtained from Patterson-Kelley) were used to dry mix titanium dioxide (TiO₂) (obtained from Sachtleben Chemie GmbH, Duisburg, Germany, under the trade designation “HOMBIFINE-N”) with Comparative Example 2. Mixtures containing Comparative Example 2 (300 g) and TiO₂ (85 g) were loaded into each chamber of the twin ‘V’ blender. Both blenders were tumbled at the rate of 20-22 rpm for 3 hours. The dry coating of white TiO₂ powder on the surface of Comparative Example 2 provided the new product Example 21.

Odorant testing was conducted using a GC\MS instrument (HP5973 MSD+HP5973 GC with a G1888 headspace autosampler; Agilent Technologies, Santa Clara, Calif.) according to the following procedure. A reference stock solution containing 1 mL each of the four odorants methanethiol, ethanethiol, triethylamine, and dimethyl disulfide was prepared. A 6 microliter sample of the odorant stock solution was added to a small glass tube. The tube was sealed in a headspace vial fitted with a Teflon lined septum. and the vial was positioned in the headspace autosampler. Measurements from this reference sample established the base response. Example 21 (150 mg) was added to a microporous film pouch. The pouch was placed in a headspace vial together with the glass tube containing the 6 microliter sample of the odorant stock solution. The pouch and odorant sample were placed in a manner to prevent any contact of the odorant liquid with the coated porous particles. The headspace vial was sealed as above and positioned in the autosampler. A total of six replicates were conducted. The results of the individual replicates were averaged and reported in the format of percent reduction in peak area for each odorant as compared to the reference sample. The same test was conducted with Comparative Example 1 and the results for both Comparative Example 1 and Example 21 are presented in Table 15.

TABLE 15

| | | | | dimethyl |
|---|---|---|---|---|
| | methanethiol | ethanethiol | triethylamine | disulfide |
| Comparative | 99.92% | 99.43% | 61.14% | 83.21% |
| Example 1 | | | | |
| Example 20 | 99.99% | 99.97% | 88.96% | 89.52% |

All patents and publications referred to herein are hereby incorporated by reference in their entirety. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A masked porous particle comprising:
a porous particle with an outer surface; and
a non-polymeric masking powder on at least a portion of the outer surface of the porous particle,
wherein the non-polymeric masking powder is not attached to the outer surface of the porous particle with a polymeric binder, and wherein the masked porous particle has a hydrophobic outer surface.

2. The masked porous particle of claim 1, wherein the porous particle is an activated carbon particle.

3. The masked porous particle of claim 1, wherein the porous particle is a zeolite particle.

4. The masked porous particle of claim 1, wherein the non-polymeric masking powder is an anionic clay.

5. The masked porous particle of claim 4, wherein the anionic clay is intercalated with an organic acid.

6. The masked porous particle of claim 5, wherein the organic acid is a monofunctional or difunctional aliphatic carboxylic acid having at least 6 carbon atoms.

7. The masked porous particle of claim 4, wherein the anionic clay is hydrotalcite.

8. The masked porous particle of claim 1, wherein the non-polymeric masking powder is hydrophobic titanium dioxide.

9. The masked porous particle of claim 1, wherein the non-polymeric masking powder is a whitening agent having an L* value of at least 55.

10. The masked porous particle of claim 1, wherein the porous particle has a surface treatment providing covalently bonded hydrophobic groups on at least a portion of its outer surface, with the non-polymeric masking powder on at least a portion of the treated outer surface.

11. The masked porous particle of claim 10, wherein the hydrophobic groups comprise siloxanes having alkyl groups, aryl groups, or combinations thereof.

12. The masked porous particle of claim 1, wherein the porous particle further comprises an odor-reducing agent within at least some of its pores.

13. The masked porous particle of claim 1, wherein a plurality of the masked porous particles has an adsorption capacity for at least one odiferous agent that is at least 60% of an adsorption capacity of a comparative plurality of porous particles for the odiferous agent, wherein the comparative plurality of porous particles is the same as the plurality of the masked porous particles except without any masking powder or hydrophobic surface treatment.

14. The masked porous particle of claim 1, wherein when exposed to aqueous liquid, a plurality of the masked porous particles adsorbs at least one odiferous agent to a greater extent than a comparative plurality of particles that is the same as the plurality of the masked porous particles except without any masking powder or hydrophobic surface treatment.

15. A plurality of particles comprising the masked porous particle of claim 1 and at least one of superabsorbent polymers, hydrophilic nonwovens, or wood pulp.

16. An absorbent component comprising an absorbent material in combination with a plurality of particles comprising the masked porous particle of claim 1.

17. An absorbent article comprising a plurality of the masked porous particles of claim 1.

18. A method of making the masked porous particle of claim 1, the method comprising:
providing the porous particle; and
dry blending the non-polymeric masking powder with the porous particle to provide the masked porous particle.

19. The method of claim 18, wherein the non-polymeric masking powder is an anionic clay intercalated with an organic acid.

20. The method of claim 18, wherein the porous particle has a surface treatment providing covalently bonded hydrophobic groups on at least a portion of its outer surface.
